(19) United States
(12) Patent Application Publication
(10) Pub. No.: US 2026/0193077 A1
(43) Pub. Date: Jul. 9, 2026

(54) SYSTEMS AND METHODS FOR CLEANING ELEVATED OPEN STORAGE TANKS

(71) Applicant: Industrial Vacuum Transfer Services USA, LLC, Houston, TX (US)

(72) Inventors: Randall Earl Thomas, Harwood, TX (US); Reggie Boggs, Harwood, TX (US); Ryan Thomas, Harwood, TX (US); Steve Blum, Harwood, TX (US)

(21) Appl. No.: 19/553,722

(22) Filed: Mar. 2, 2026

Related U.S. Application Data
(63) Continuation-in-part of application No. 18/791,532, filed on Aug. 1, 2024.
Application No. 18/791,532 is a division of application No. 17/811,277, filed on Jul. 7, 2022, now Pat. No. 12,098,068.
(63) Continuation-in-part of application No. 18/888,586, filed on Sep. 18, 2024.
Application No. 18/888,586 is a division of application No. 17/811,293, filed on Jul. 7, 2022, now Pat. No. 12,137,864.
(63) Continuation-in-part of application No. 18/772,561, filed on Jul. 15, 2024.
Application No. 18/772,561 is a division of application No. 17/811,295, filed on Jul. 7, 2022, now Pat. No. 12,091,264.
(63) Continuation-in-part of application No. 18/792,645, filed on Aug. 2, 2024.
Application No. 18/792,645 is a continuation of application No. 17/811,280, filed on Jul. 7, 2022, now Pat. No. 12,103,791.
(63) Continuation-in-part of application No. 18/963,431, filed on Nov. 27, 2024.
Application No. 18/963,431 is a division of application No. 17/811,291, filed on Jul. 7, 2022, now Pat. No. 12,193,627.
(63) Continuation-in-part of application No. 19/011,864, filed on Jan. 7, 2025.
Application No. 19/011,864 is a continuation of application No. 17/811,288, filed on Jul. 7, 2022, now Pat. No. 12,246,932.
(63) Continuation-in-part of application No. 19/367,957, filed on Oct. 24, 2025.
Application No. 19/367,957 is a division of application No. 18/214,887, filed on Jun. 27, 2023, now Pat. No. 12,510,077.
Application No. 18/214,887 is a continuation-in-part of application No. 17/811,277, filed on Jul. 7, 2022, now Pat. No. 12,098,068.
Application No. 18/214,887 is a continuation-in-part of application No. 17/811,293, filed on Jul. 7, 2022, now Pat. No. 12,137,864.
Application No. 18/214,887 is a continuation-in-part of application No. 17/811,295, filed on Jul. 7, 2022, now Pat. No. 12,091,264.
Application No. 18/214,887 is a continuation-in-part of application No. 17/811,280, filed on Jul. 7, 2022, now Pat. No. 12,103,791.
Application No. 18/214,887 is a continuation-in-part of application No. 17/811,291, filed on Jul. 7, 2022, now Pat. No. 12,193,627.
Application No. 18/214,887 is a continuation-in-part of application No. 17/811,288, filed on Jul. 7, 2022, now Pat. No. 12,246,932.
(63) Continuation-in-part of application No. 19/371,759, filed on Oct. 28, 2025.
Application No. 19/371,759 is a division of application No. 18/459,545, filed on Sep. 1, 2023, now Pat. No. 12,485,459.
Application No. 18/459,545 is a continuation-in-part of application No. 18/214,887, filed on Jun. 27, 2023, now Pat. No. 12,510,077.
Application No. 18/214,887 is a continuation-in-part of application No. 17/811,295, filed on Jul. 7, 2022, now Pat. No. 12,091,264.
Application No. 18/214,887 is a continuation-in-part of application No. 17/811,293, filed on Jul. 7, 2022, now Pat. No. 12,137,864.
Application No. 17/811,293 is a continuation-in-part of application No. 17/811,291, filed on Jul. 7, 2022, now Pat. No. 12,193,627.
Application No. 18/214,887 is a continuation-in-part of application No. 17/811,288, filed on Jul. 7, 2022, now Pat. No. 12,246,932.
Application No. 18/214,887 is a continuation-in-part of application No. 17/811,280, filed on Jul. 7, 2022, now Pat. No. 12,103,791.
Application No. 18/214,887 is a continuation-in-part of application No. 17/811,277, filed on Jul. 7, 2022, now Pat. No. 12,098,068.
(60) Provisional application No. 63/203,108, filed on Jul. 8, 2021.
(60) Provisional application No. 63/203,108, filed on Jul. 8, 2021.
(60) Provisional application No. 63/203,108, filed on Jul. 8, 2021.
(60) Provisional application No. 63/203,108, filed on Jul. 8, 2021.
(60) Provisional application No. 63/203,108, filed on Jul. 8, 2021.
(60) Provisional application No. 63/203,108, filed on Jul. 8, 2021.
(60) Provisional application No. 63/203,108, filed on Jul. 8, 2021.
(60) Provisional application No. 63/203,108, filed on Jul. 8, 2021.
(60) Provisional application No. 63/203,108, filed on Jul. 8, 2021.
(60) Provisional application No. 63/203,108, filed on Jul. 8, 2021.
(60) Provisional application No. 63/203,108, filed on Jul. 8, 2021.
(60) Provisional application No. 63/203,108, filed on Jul. 8, 2021.
(60) Provisional application No. 63/203,108, filed on Jul. 8, 2021.
(60) Provisional application No. 63/203,147, filed on Jul. 9, 2021.
(60) Provisional application No. 63/203,147, filed on Jul. 9, 2021.
(60) Provisional application No. 63/203,147, filed on Jul. 9, 2021.
(60) Provisional application No. 63/203,147, filed on Jul. 9, 2021.
(60) Provisional application No. 63/203,147, filed on Jul. 9, 2021.
(60) Provisional application No. 63/203,147, filed on Jul. 9, 2021.
(60) Provisional application No. 63/203,147, filed on Jul. 9, 2021.
(60) Provisional application No. 63/203,147, filed on Jul. 9, 2021.
(60) Provisional application No. 63/203,147, filed on Jul. 9, 2021.
(60) Provisional application No. 63/203,147, filed on Jul. 9, 2021.
(60) Provisional application No. 63/203,147, filed on Jul. 9, 2021.
(60) Provisional application No. 63/203,147, filed on Jul. 9, 2021.
(60) Provisional application No. 63/203,147, filed on Jul. 9, 2021.
(60) Provisional application No. 63/264,015, filed on Nov. 12, 2021.
(60) Provisional application No. 63/264,015, filed on Nov. 12, 2021.
(60) Provisional application No. 63/264,015, filed on Nov. 12, 2021.
(60) Provisional application No. 63/264,015, filed on Nov. 12, 2021.
(60) Provisional application No. 63/264,015, filed on Nov. 12, 2021.
(60) Provisional application No. 63/264,015, filed on Nov. 12, 2021.
(60) Provisional application No. 63/264,015, filed on Nov. 12, 2021.
(60) Provisional application No. 63/264,015, filed on Nov. 12, 2021.
(60) Provisional application No. 63/264,015, filed on Nov. 12, 2021.
(60) Provisional application No. 63/264,015, filed on Nov. 12, 2021.
(60) Provisional application No. 63/264,015, filed on Nov. 12, 2021.
(60) Provisional application No. 63/264,015, filed on Nov. 12, 2021.
(60) Provisional application No. 63/264,015, filed on Nov. 12, 2021.
(60) Provisional application No. 63/264,101, filed on Nov. 16, 2021.
(60) Provisional application No. 63/264,101, filed on Nov. 16, 2021.
(60) Provisional application No. 63/264,101, filed on Nov. 16, 2021.
(60) Provisional application No. 63/264,101, filed on Nov. 16, 2021.
(60) Provisional application No. 63/264,101, filed on Nov. 16, 2021.
(60) Provisional application No. 63/264,101, filed on Nov. 16, 2021.
(60) Provisional application No. 63/264,101, filed on Nov. 16, 2021.
(60) Provisional application No. 63/264,101, filed on Nov. 16, 2021.
(60) Provisional application No. 63/264,101, filed on Nov. 16, 2021.
(60) Provisional application No. 63/264,101, filed on Nov. 16, 2021.
(60) Provisional application No. 63/264,101, filed on Nov. 16, 2021.
(60) Provisional application No. 63/264,101, filed on Nov. 16, 2021.
(60) Provisional application No. 63/264,101, filed on Nov. 16, 2021.
(60) Provisional application No. 63/364,630, filed on May 13, 2022.
(60) Provisional application No. 63/364,630, filed on May 13, 2022.
(60) Provisional application No. 63/364,630, filed on May 13, 2022.
(60) Provisional application No. 63/364,630, filed on May 13, 2022.
(60) Provisional application No. 63/364,630, filed on May 13, 2022.
(60) Provisional application No. 63/364,630, filed on May 13, 2022.
(60) Provisional application No. 63/364,630, filed on May 13, 2022.
(60) Provisional application No. 63/364,630, filed on May 13, 2022.
(60) Provisional application No. 63/364,630, filed on May 13, 2022.
(60) Provisional application No. 63/364,630, filed on May 13, 2022.
(60) Provisional application No. 63/364,630, filed on May 13, 2022.
(60) Provisional application No. 63/364,630, filed on May 13, 2022.
(60) Provisional application No. 63/364,630, filed on May 13, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,219, filed on Jun. 29, 2022.
(60) Provisional application No. 63/367,218, filed on Jun. 29, 2022.
(60) Provisional application No. 63/367,570, filed on Jul. 1, 2022.
(60) Provisional application No. 63/367,570, filed on Jul. 1, 2022.
(60) Provisional application No. 63/367,570, filed on Jul. 1, 2022.
(60) Provisional application No. 63/367,570, filed on Jul. 1, 2022.
(60) Provisional application No. 63/367,570, filed on Jul. 1, 2022.
(60) Provisional application No. 63/367,570, filed on Jul. 1, 2022.
(60) Provisional application No. 63/367,570, filed on Jul. 1, 2022.
(60) Provisional application No. 63/367,570, filed on Jul. 1, 2022.
(60) Provisional application No. 63/367,570, filed on Jul. 1, 2022.
(60) Provisional application No. 63/367,570, filed on Jul. 1, 2022.
(60) Provisional application No. 63/367,570, filed on Jul. 1, 2022.
(60) Provisional application No. 63/367,570, filed on Jul. 1, 2022.
(60) Provisional application No. 63/367,570, filed on Jul. 1, 2022.
(60) Provisional application No. 63/373,289, filed on Aug. 23, 2022.
(60) Provisional application No. 63/373,289, filed on Aug. 23, 2022.
(60) Provisional application No. 63/375,500, filed on Sep. 13, 2022.
(60) Provisional application No. 63/765,971, filed on Mar. 3, 2025.

(51) Int. Cl. B67D 7/02; B01D 46/42; B01D 46/44

(52) U.S. Cl. CPC B67D 7/0277; B01D 46/4236; B01D 46/4245; B01D 46/444; B01D 2279/55

(57) ABSTRACT

Systems, assemblies, and method to extract undesired materials from an elevated open storage tank are described herein. An embodiment of a system may include one or more vacuum generation assemblies, each having at least one compressor configured to provide a pressurized fluid and venturi mechanisms configured to receive the pressurized fluid and generate a vacuum flow using a venturi effect. The system may include a submersible robot being positioned to deliver a pressurized water stream via a water jet to fluidize sludge within the elevated open storage tank, and configured to extract the fluidized sludge from the elevated open storage tank via a suction head that receives the vacuum flow. The system may include one or more sludge processing devices configured to receive and process the fluidized sludge, thereby to yield a recovered water stream and sediment, the recovered water stream being recycled to form at least a portion of the pressurized water stream.

### RELATED APPLICATIONS

This U.S. non-provisional application claims priority to and the benefit of U.S. Provisional Application No. 63/765,971, filed Mar. 3, 2025, titled “SYSTEMS AND METHODS FOR CLEANING ELEVATED OPEN STORAGE TANKS,” and is a continuation-in-part of U.S. non-provisional application Ser. No. 18/791,532, filed Aug. 1, 2024, titled “SYSTEMS, METHODS, AND DEVICES FOR INDUSTRIAL TOWER WASTE EXTRACTION,” which application is a divisional of U.S. non-provisional application Ser. No. 17/811,277, filed Jul. 7, 2022, titled “SYSTEMS, METHODS, AND DEVICES FOR INDUSTRIAL TOWER WASTE EXTRACTION,” now U.S. Pat. No. 12,098,068, issued Sep. 24, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. Ser. No. 18/888,586, filed Sep. 18, 2024, titled “ASSEMBLIES AND METHODS FOR MATERIAL EXTRACTION,” which is a divisional of U.S. non-provisional application Ser. No. 17/811,293, filed Jul. 7, 2022, titled “ASSEMBLIES AND METHODS FOR MATERIAL EXTRACTION,” now U.S. Pat. No. 12,137,864, issued Nov. 12, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. 18/772,561, filed Jul. 15, 2024, titled “ASSEMBLIES, APPARATUSES, SYSTEMS, AND METHODS FOR MATERIAL EXTRACTION AND CONVEYANCE,” which is a divisional of U.S. non-provisional application Ser. No. 17/811,295, filed Jul. 7, 2022, titled “ASSEMBLIES, APPARATUSES, SYSTEMS, AND METHODS FOR MATERIAL EXTRACTION AND CONVEYANCE,” now U.S. Pat. No. 12,091,264, issued Sep. 17, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. 18/792,645, filed Aug. 2, 2024, titled “ASSEMBLIES AND METHODS FOR MATERIAL EXTRACTION FROM RETENTION COLLECTIONS,” which is a continuation of U.S. non-provisional application Ser. No. 17/811,280, filed Jul. 7, 2022, titled “ASSEMBLIES AND METHODS FOR MATERIAL EXTRACTION FROM RETENTION COLLECTIONS,” now U.S. Pat. No. 12,103,791, issued Oct. 1, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. 18/963,431, filed Nov. 27, 2024, titled “HIGH VOLUME INDUSTRIAL VACUUM ASSEMBLIES AND METHODS,” which is a divisional of U.S. application Ser. No. 17/811,291, filed Jul. 7, 2022, titled “HIGH VOLUME INDUSTRIAL VACUUM ASSEMBLIES AND METHODS,” now U.S. Pat. No. 12,193,627, issued Jan. 14, 2025, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. Non-Provisional Application No. Ser. No. 19/011,864, filed Jan. 7, 2025, titled “METHODS FOR LOADING AND EXTRACTING PRODUCT IN ELEVATED TOWER,” which is a continuation of U.S. non-provisional application Ser. No. 17/811,288, filed Jul. 2, 2022, titled “METHODS FOR LOADING AND EXTRACTING PRODUCT IN ELEVATED TOWER,” now U.S. Pat. No. 12,246,932, issued Mar. 11, 2025, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. 19/367,957, filed Oct. 24, 2025, titled “AIR COMPRESSOR HAVING VACUUM AND ASSOCIATED METHODS FOR LOADING AND EXTRACTING MATERIALS,” which is a divisional of U.S. non-provisional application Ser. No. 18/214,887, filed Jun. 27, 2023, titled “AIR COMPRESSOR HAVING VACUUM AND ASSOCIATED METHODS FOR LOADING AND EXTRACTING MATERIALS,” now U.S. Pat. No. 12,510,077, issued Dec. 30, 2025, which claims the benefit of and priority to U.S. Provisional Patent Application No. 63/373,289, filed Aug. 23, 2022, and titled “AIR COMPRESSOR HAVING VACUUM AND ASSOCIATED METHODS FOR LOADING AND EXTRACTING MATERIALS,” the contents of which are incorporated herein by reference in their entirety. U.S. non-provisional application Ser. No. 18/214,887 is a continuation-in-part of U.S. non-provisional application Ser. No. 17/811,277, filed Jul. 7, 2022, titled, “SYSTEMS, METHODS, AND DEVICES FOR INDUSTRIAL TOWER WASTE EXTRACTION,” now U.S. Pat. No. 12,098,068, issued Sep. 24, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties. U.S. non-provisional application Ser. No. 18/214,887 is also a continuation-in-part of U.S. non-provisional application Ser. No. 17/811,293, filed Jul. 7, 2022, titled, “ASSEMBLIES AND METHODS FOR MATERIAL EXTRACTION,” now U.S. Pat. No. 12,137,864, issued Nov. 12, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties. U.S. non-provisional application Ser. No. 18/214,887 is also a continuation-in-part of U.S. non-provisional application Ser. No. 17/811,295, filed Jul. 7, 2022, titled, “ASSEMBLIES, APPARATUSES, SYSTEMS, AND METHODS FOR MATERIAL EXTRACTION AND CONVEYANCE,” now U.S. Pat. No. 12,091,264, issued Sep. 17, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties. U.S. non-provisional application Ser. No. 18/214,887 is also a continuation-in-part of U.S. non-provisional application Ser. No. 17/811,280, filed Jul. 7, 2022, titled, “ASSEMBLIES AND METHODS FOR MATERIAL EXTRACTION FROM RETENTION COLLECTIONS,” now U.S. Pat. No. 12,103,791, issued Oct. 1, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties. U.S. non-provisional application Ser. No. 18/214,887. This application is also a continuation-in-part of U.S. non-provisional application Ser. No. 17/811,291, filed Jul. 7, 2022, titled, “HIGH VOLUME INDUSTRIAL VACUUM ASSEMBLIES AND METHODS,” which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their U.S. non-provisional application Ser. No. 18/214,887 is also a continuation-in-part of U.S. non-provisional application Ser. No. 17/811,288, filed Jul. 7, 2022, titled, “RECEIVER, ASSEMBLIES, AND METHODS FOR LOADING AND EXTRACTING PRODUCT INELEVATED TOWER,” which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. 19/371,759, filed Oct. 28, 2025, titled “SYSTEMS, ASSEMBLIES, AND METHODS FOR PYROPHORIC MATERIAL EXTRACTION,” which is a divisional of U.S. non-provisional application ser. No. 18/459,545, filed Sep. 1, 2023, titled “SYSTEMS, ASSEMBLIES, AND METHODS FOR PYROPHORIC MATERIAL EXTRACTION,” now U.S. Pat. No. 12,485,459, issued Dec. 2, 2025, which claims priority to and the benefit of U.S. Provisional Application No. 63/375,500, filed Sep. 13, 2022, titled “SYSTEMS, ASSEMBLIES, AND METHODS FOR PYROPHORIC MATERIAL EXTRACTION.” U.S. non-provisional application Ser. No. 18/459,545 is also a continuation-in-part of U.S. non-provisional application Ser. No. 18/214,887, filed Jun. 27, 2023, titled “AIR COMPRESSOR HAVING VACUUM AND ASSOCIATED METHODS FOR LOADING AND EXTRACTING MATERIALS,” which claims the benefit of and priority to U.S. Provisional Ser. No. 63/373,289 , filed Aug. 23, 2022, titled “AIR COMPRESSOR HAVING VACUUM AND ASSOCIATED METHODS FOR LOADING AND EXTRACTING MATERIALS”; and is a continuation-in-part of and claims benefit and priority to U.S. non-provisional application Ser. No. 17/811,295, filed Jul. 7, 2022, titled, “ASSEMBLIES, APPARATUSES, SYSTEMS, AND METHODS FOR MATERIAL EXTRACTION AND CONVEYANCE,” now U.S. Pat. No. 12,091,264, issued Sep. 17, 2024, which claims the benefit of and priority to U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE”; and is a continuation-in-part of and claims benefit and priority to U.S. non-provisional application Ser. No. 17/811,293, filed Jul. 7, 2022, titled, “ASSEMBLIES AND METHODS FOR MATERIAL EXTRACTION” now U.S. Pat. No. 12,137,864, issued Nov. 12, 2024; and is a continuation-in-part of and claims benefit and priority to U.S. non-provisional application Ser. No. 17/811,291, filed Jul. 7, 2022, titled, “HIGH VOLUME INDUSTRIAL VACUUM ASSEMBLIES AND METHODS,” which claims the benefit of and priority to U.S. Provisional Application No. 63/367,570, filed Jul. 1, 2022, titled “HIGH VOLUME INDUSTRIAL VACUUM ASSEMBLIES AND METHODS”; and is a continuation-in-part of and claims benefit and priority to U.S. non-provisional application Ser. No. 17/811,288, filed Jul. 7, 2022, titled, “RECEIVER, ASSEMBLIES, AND METHODS FOR LOADING AND EXTRACTING PRODUCT INELEVATED TOWER,” which claims the benefit of and priority to U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER”; and is a continuation-in-part of and claims benefit and priority to U.S. non-provisional application Ser. No. 17/811,280, filed Jul. 7, 2022, titled, “ASSEMBLIES AND METHODS FOR MATERIAL EXTRACTION FROM RETENTION COLLECTIONS,” now U.S. Pat. No. 12,103,791, issued Oct. 1, 2024, which claims the benefit of and priority to U.S. Provisional Application No. 63/367,218, filed Jun. 29, 2022, titled “ASSEMBLIES AND METHODS FOR MATERIAL EXTRACTION FROM RETENTION COLLECTIONS”; and is a continuation-in-part of and claims benefit and priority to U.S. non-provisional application Ser. No. 17/811,277, filed Jul. 7, 2022, titled, “SYSTEMS, METHODS, AND DEVICES FOR INDUSTRIAL TOWER WASTE EXTRACTION,” now U.S. Pat. No. 12,098,068, issued Sep. 24, 2024, which claims the benefit of and priority to U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

### TECHNICAL FIELD

The present disclosure relates to assemblies and methods for extracting undesired material from a storage site and, more particularly, to assemblies and methods for extracting sludge from elevated open storage tank.

### BACKGROUND

Certain environments, such as, for example, work sites, industrial sites, commercial sites, residential sites, or natural sites, may often be sources of material that is either deposited or accumulates as a result of operations at the site or through natural accumulation. The deposit or accumulation of the material may be undesirable for a number of reasons, and thus, removal of the material from the site may be desirable or necessary. For example, the presence of the material in sufficient quantities may hinder operations at the site, may present an undesirable environmental condition, and/or may present recycling or remediation opportunities. Traditional approaches to removal of the material from the site may be unsatisfactory or suffer from drawbacks for various reasons. For example, the material may take a variety of forms (e.g., liquids, solids, emulsions, particulates, etc.) and/or may be located or positioned, such that it is difficult to extract and remove from the site, and/or traditional methods may be impracticable, inefficient, unduly time consuming, and/or labor intensive.

Accordingly, Applicant has recognized a desire to provide improved assemblies and methods for extracting material from a site, including a variety of different materials from a variety of different environments, which may be more practicable, more efficient, less time consuming, and/or less labor intensive. The present disclosure may address one or more of the above-referenced drawbacks, as well as other possible drawbacks.

### SUMMARY

As referenced above, it may be desirable to provide improved assemblies and methods for extracting material from a location, including a variety of different materials from a variety of different environments, that may be more practicable, more efficient, less time consuming, and/or less labor intensive. For example, the intentional generation or production of some materials for desired intermediate or final products may result in the deposit or accumulation of by-product materials or waste materials that need to be removed from the environment in which the desired products are generated, produced, or stored. In some embodiments, the assemblies and methods may provide efficient extraction of the material to be removed from various environments, such as, for example, work sites, industrial sites, commercial sites, residential sites, or natural sites, among others. For example, in some embodiments, the material may be extracted in a substantially continuous manner and/or may be extracted without significant contamination of the ambient environment with the material or portions thereof.

Embodiments of a system for extracting and processing sludge from an elevated open storage tank are described herein. In some embodiments, the system includes one or more vacuum generation assemblies, the one or more vacuum generation assemblies having one or more compressors configured to provide a pressurized fluid and one or more vacuum generators, each having one or more venturi mechanisms configured to receive the pressurized fluid and generate a vacuum flow using a venturi effect. In some embodiments, the system includes a submersible robot including a water jet configured to receive a pressurized water stream and a suction head configured to receive the vacuum flow generated by the one or more vacuum generation assemblies, in which the submersible robot is configured to deliver the pressurized water stream via the water jet to fluidize the sludge within the elevated open storage tank, thereby to yield a fluidized sludge, and configured to extract the fluidized sludge from the elevated open storage tank via the suction head. In some embodiments, the system includes one or more sludge processing devices configured to receive and process the fluidized sludge, thereby to yield a recovered water stream and sediment, the recovered water stream being recycled to form at least a portion of the pressurized water stream.

In some embodiments, the one or more vacuum generation assemblies are configured to generate a pressure that ranges from about X Pascals to about Y Pascals to generate the vacuum flow. In some embodiments, the vacuum flow generated by the one or more vacuum generation assemblies ranges from about X cubic feet per minute to about Y cubic feet per minute. In some embodiments, the water jet of the submersible robot is fluidly connected to a water pump via a high-pressure hose to receive the pressurized water stream, and the suction head of the submersible robot is fluidly connected to the one or more vacuum generation assemblies via a vacuum hose having a diameter of at least 6 inches to receive the vacuum flow.

In some embodiments, the system includes a plurality of vacuum boxes configured to receive and collect the fluidized sludge extracted by the submersible robot and configured to provide the fluidized sludge to the one or more sludge processing devices. In some embodiments, the plurality of vacuum boxes is fluidly connected to (i) the one or more vacuum generation assemblies to receive the vacuum flow, (ii) the submersible robot to provide the vacuum flow to the suction head, and (iii) the one or more sludge processing devices to provide the fluidized sludge to the one or more sludge processing devices. In some embodiments, the system includes a diaphragm pump fluidly connected between the plurality of vacuum boxes and the one or more sludge processing devices, in which the diaphragm pump is configured to pump the fluidized sludge from the plurality of vacuum boxes to the one or more sludge processing devices. In some embodiments, the plurality of vacuum boxes each include one or more water jets fluidly connected to a water pump and configured to receive and deliver a second pressurized water stream to maintain or restore fluidization of the fluidized sludge within the plurality of vacuum boxes. In some embodiments, the recovered water stream is recycled to form at least a portion of the second pressurized water stream.

In some embodiments, the one or more sludge processing devices include a shaker, a desander, a desilter, a centrifuge, or any combination thereof. In some embodiments, the system includes a flocculant supply configured to combine one or more flocculants with the fluidized sludge before or during processing the fluidized sludge within one or more sludge processing devices. In some embodiments, the elevated open storage tank has a height of at least 45 feet, and the one or more vacuum generation assemblies include a first vacuum generation assembly having a first vacuum generator with four venturi mechanisms fluidly connected to receive the pressurized fluid from a first compressor, and a second vacuum generation assembly having a second vacuum generator with four venturi mechanisms fluidly connected to receive the pressurized fluid from a second compressor. In some embodiments, the one or more compressors include one or more air compressors, and the pressurized fluid includes compressed air. In some embodiments, the one or more vacuum generation assemblies include one or more hydrogen sulfide (H₂S) scrubbers fluidly connected to the one or more vacuum generation assemblies and configured to remove H₂S gas from an exhaust stream of the one or more venturi mechanisms of the one or more vacuum generators.

Embodiments of a method of extracting and processing sludge from an elevated open storage tank are also described herein. In some embodiments, the method includes lowering a submersible robot through an open top of the elevated open storage tank. In some embodiments, the method includes activating a first water pump to supply a first pressurized water stream to a water jet of the submersible robot, thereby to yield a fluidized sludge. In some embodiments, the method includes activating one or more vacuum generation assemblies to provide a vacuum flow to a suction head of the submersible robot, thereby to extract the fluidized sludge from the elevated open storage tank using the vacuum flow. In some embodiments, the method includes providing the fluidized sludge to one or more sludge processing devices. In some embodiments, the method includes activating the one or more sludge processing devices to process the fluidized sludge, thereby to yield a recovered water stream and sediment. In some embodiments, the method includes recycling the recovered water stream to form at least a portion of the first pressurized water stream.

In some embodiments, the lowering of the submersible robot through the open top of the elevated open storage tank includes providing control signals to a crane operably connected to the submersible robot to cause the crane to lower the submersible robot through the open top of the elevated open storage tank. In some embodiments, the providing of the fluidized sludge to the one or more sludge processing devices includes delivering the fluidized sludge extracted by the suction head of the submersible robot directly to the one or more sludge processing devices via a vacuum hose that is fluidly connected between the suction head of the submersible robot and the one or more sludge processing devices. In some embodiments, the providing of the fluidized sludge to the one or more sludge processing devices includes delivering the fluidized sludge into a plurality of vacuum boxes and activating a diaphragm pump to pump the fluidized sludge from the plurality of vacuum boxes to the one or more sludge processing devices.

In some embodiments, the method includes determining that a volume of the fluidized sludge in the plurality of vacuum boxes is less than a predefined minimum volume, and in response, deactivating at least the diaphragm pump and the one or more sludge processing devices to cease sludge processing until the volume of the fluidized sludge in the plurality of vacuum boxes is greater than or equal to the predefined minimum volume. In some embodiments, the method includes determining that a volume of the fluidized sludge in the plurality of vacuum boxes is greater than a predefined maximum volume, and in response, deactivating at least the one or more vacuum generation assemblies and the first water pump to cease sludge extraction and collection until the volume of the fluidized sludge in the plurality of vacuum boxes is less than or equal to the predefined maximum volume.

In some embodiments, the providing of the fluidized sludge to the one or more sludge processing devices further includes activating a second water pump to supply a second pressurized water stream to one or more vacuum box water jets to maintain or restore fluidization of the fluidized sludge within the plurality of vacuum boxes. In some embodiments, the providing of the fluidized sludge to the one or more sludge processing devices includes combining the fluidized sludge with one or more flocculants and providing the combination of the fluidized sludge and the one or more flocculants to the one or more sludge processing devices for processing.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to illustrate embodiments of the disclosure more clearly.

FIG. 1A is a schematic side view of a sludge extraction zone of an example material extraction assembly, according to embodiments of the disclosure.

FIG. 1B is a schematic side view of a sludge collection zone of the example material extraction assembly, according to embodiments of the disclosure.

FIG. 1C is a schematic side view of a sludge processing zone of the example material extraction assembly, according to embodiments of the disclosure.

FIG. 1D is a schematic side view of a vacuum source zone of the example material extraction assembly, according to embodiments of the disclosure.

FIG. 2A is a schematic top view of an example vacuum generation and sound attenuation assembly, according to embodiments of the disclosure.

FIG. 2B is schematic side view of the example vacuum generation and sound attenuation assembly shown in FIG. 2A, according to embodiments of the disclosure.

FIG. 2C is schematic side view of an interior of an example vacuum generation and sound attenuation assembly, demonstrating an example layout of components and airflows, according to embodiments of the disclosure.

FIG. 2D is schematic side view of a partial interior of an example vacuum generation and sound attenuation assembly, according to embodiments of the disclosure.

FIG. 2E is schematic end view of the example vacuum generation and sound attenuation assembly shown in FIG. 2A, according to embodiments of the disclosure.

FIG. 2F is schematic side view of a partial interior of an example vacuum generation and sound attenuation assembly, according to embodiments of the disclosure.

FIG. 2G is schematic end view of the example vacuum generation and sound attenuation assembly shown in FIG. 2E, according to embodiments of the disclosure.

FIG. 2H is a schematic view of a portion of an example vacuum generator, according to embodiments of the disclosure.

FIG. 2I is a schematic top perspective view of an example sound attenuation assembly, with example filter media visible, according to embodiments of the disclosure.

FIG. 2J is a schematic end section view of an example sound attenuation chamber, according to embodiments of the disclosure.

FIG. 3 is a process flow diagram illustrating an example material extraction assembly that includes a sludge collection zone, according to embodiments of the disclosure.

FIG. 4 is a process flow diagram illustrating another example material extraction assembly that lacks a sludge collection zone, according to embodiments of the disclosure.

FIG. 5 is a flow diagram illustrating an example method of sludge extraction, according to embodiments of the disclosure.

FIG. 6 is a flow diagram illustrating an example method of sludge collection, according to embodiments of the disclosure.

FIG. 7 is a flow diagram illustrating an example method of sludge processing, according to embodiments of the disclosure.

FIG. 8 is a flow diagram illustrating an example method of managing sludge collection and processing, according to embodiments of the disclosure.

FIG. 9 is a diagrammatic representation of a control system associated with the material extraction assembly, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

As used herein, “water” refers to pure water or an aqueous liquid that contains dissolved substances (e.g., dissolved salts, acids, bases) and/or non-miscible or non-soluble liquid substances (e.g., oils, hydraulic fluids, fuels). As used herein, “sediment” refers to particulates that are partially or entirely insoluble water. As used herein, the term “sludge” refers a mixture of water and sediment. For example, sludge may include natural sediment particulates (e.g., soil, dust, dirt, mud), corrosion byproducts (e.g., rust, metal oxides), chemical reaction by-products (e.g., spent catalyst particulates, unreacted starting materials, reaction intermediates, reaction products), manufacturing by-products (e.g., abrasive particles, refractory materials, waxes, metallic shavings, saw dust), oil and gas exploration or recovery by-products (e.g., drilling fluids, muds, proppants) or other particulates dispersed or suspended in water.

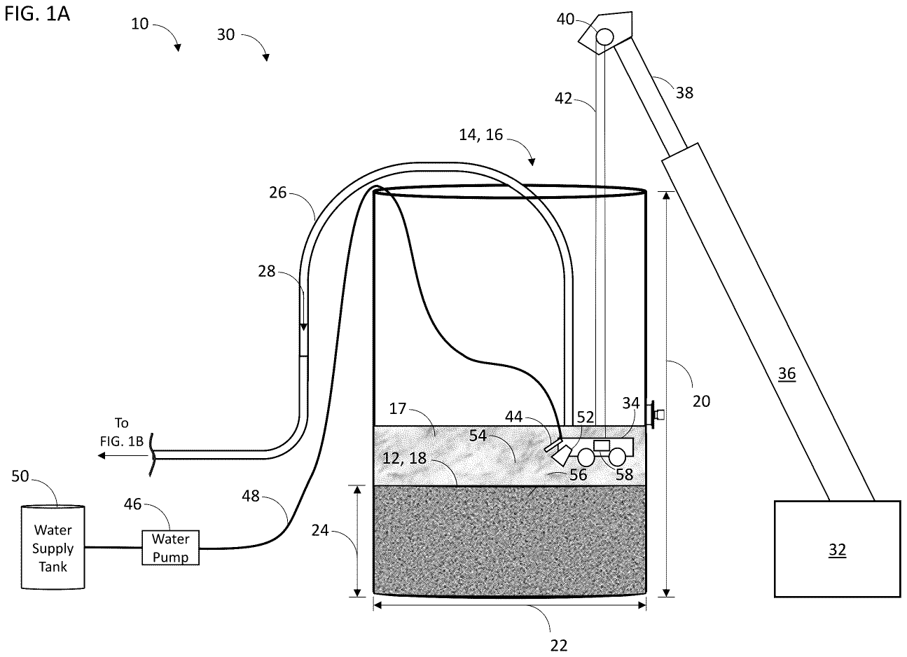

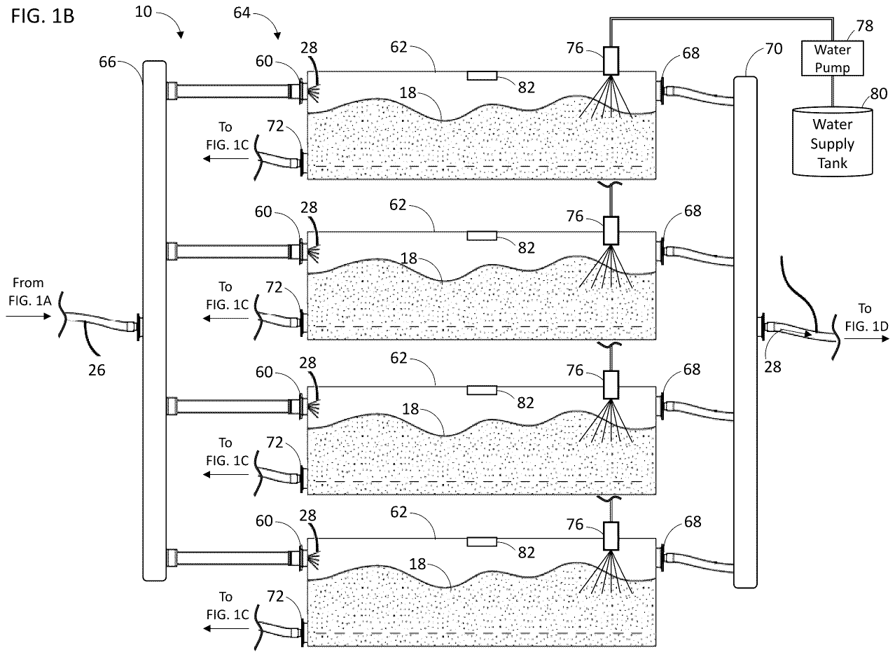

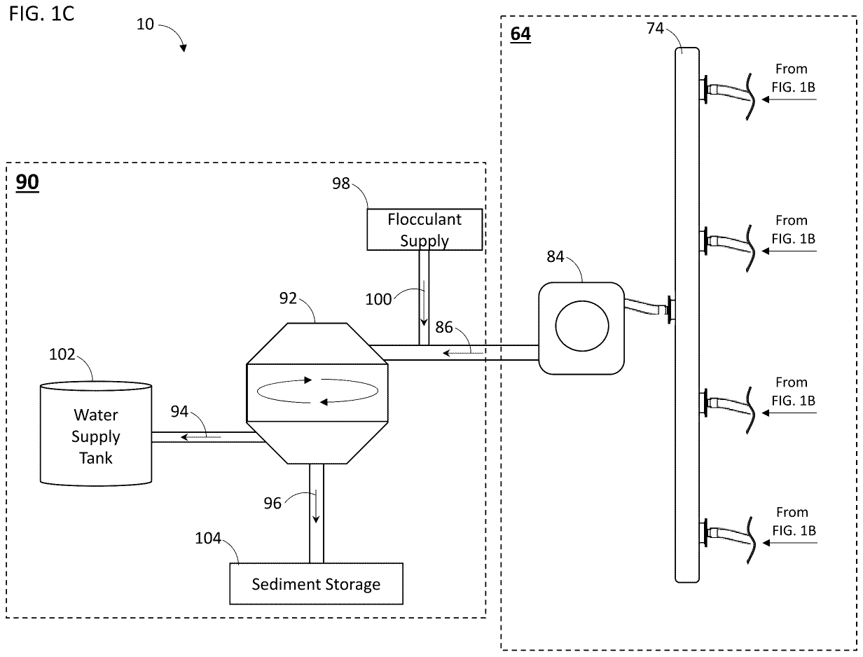

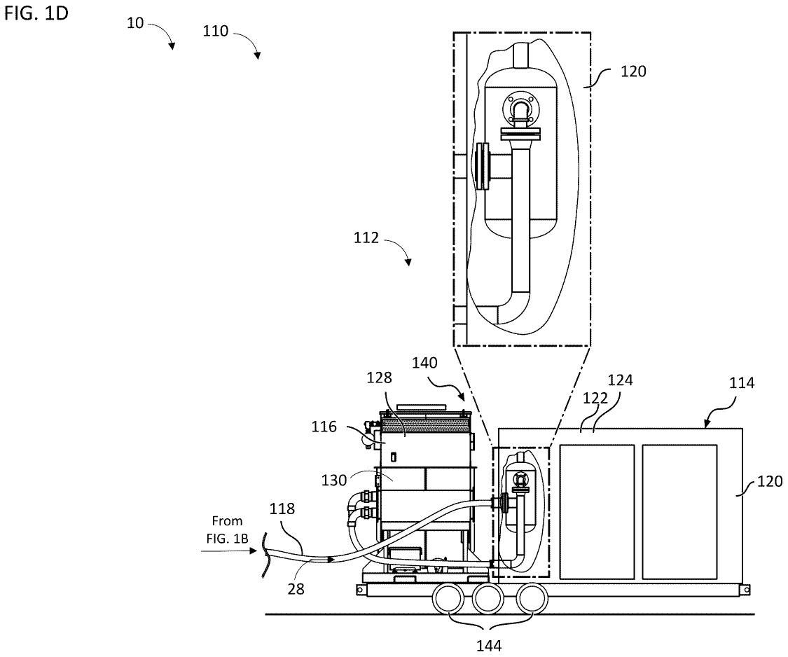

FIGS. 1A, 1B, 1C, and 1D are schematic views of an example material extraction assembly 10, according to embodiments of the disclosure. The example material extraction assembly 10 may be configured to extract undesired material 12 from a storage site 14. For the illustrated embodiment, the material extraction assembly 10 is configured to extract undesired material 12 from an elevated open storage tank 16. For the illustrated embodiment, the elevated open storage tank 16 may include water 17 and undesired material 12. For the illustrated example, the undesired material 12 includes sludge 18. The sludge (or the sediment contained therein) may be produced by operations of a facility, such as an oil and gas production facility, an oil and gas processing facility, a chemical processing facility, or an industrial manufacturing facility. During the operation of one or more processes at the facility, undesired material 12 may be generated and/or stored within the elevated open storage tank 16. For example, the intentional generation or production of some materials for desired intermediate or final products may result in the deposit or accumulation of by-products or other materials used to facilitate the production of the desired products that need to be removed from the environment. In some embodiments, the assemblies, apparatuses, systems, and methods described herein may provide efficient extraction of the undesired material 12 to be removed from various environments, such as, for example, work sites, industrial sites, commercial sites, residential sites, or natural sites, among others. For example, an industrial site may include, for example, chemical reaction towers (or other types of reaction vessels) in which chemical reactions are performed to obtain desirable products. In some embodiments, the undesired material 12 may be at least partially generated as a by-product from the chemical reactions. Additionally, because the storage tank 16 is open (i.e., no cover or top), precipitation (e.g., rain, sleet, snow) and additional particulates (e.g., dust, sand, soil) may also accumulate within the elevated open storage tank 16, increasing the volume of undesired material 12 within the tank 16 over time. In some embodiments, the elevated open storage tank 16 may serve as a collection site for water recovered from one or more industrial processes, such as industrial processes that utilize water as a heat transfer medium.

As the volume of the undesired material 12 accumulates within the elevated open storage tank 16, the volume of water that can be stored and retrieved from the tank 16 is reduced. The undesired material 12 may further interfere with the operation of equipment (e.g., valves, pumps, flow meters) associated with the elevated open storage tank 16 and/or the operations of the facility. As such, the elevated open storage tank 16 may be intermittently cleaned to remove the undesired material 12 from the tank 16 to improve the operation of the equipment and/or the facility. However, the Applicant has recognized that the cleaning of elevated open storage tanks can be challenging. First, the elevated open storage tank 16 may be large and may contain a large volume of undesired material 12. For example, the elevated open storage tank 16 of the embodiment represented in FIG. 1A (not drawn to scale) may have a height 20 of about 45 feet and a diameter 22 of about 85 feet and may have a layer of sludge 18 fills the bottom of the tank to a height 24 of about 12 feet. For this example, this represents a sludge volume greater than 19,000 cubic feet, which is a substantial volume of undesired material 12 to be removed. Additionally, depending on the composition of the sludge and/or the water, there may be regulatory constraints on how the materials within the tank are handled and processed. For example, manual removal of the undesired material 12 may be inefficient or completely infeasible. Furthermore, attempting to use certain heavy equipment (e.g., excavators, dredges) to remove the undesired material 12 may also be infeasible, for example, due to the height 20 of the tank 16, the consistency of the undesired material 12, and/or the risk of damaging the tank during the sludge extraction process. Furthermore, in some cases, it may be desirable for the elevated open storage tank 16 to remain operational during cleaning, for example, to continue to serve as a water supply that is used as a heat transfer medium for heating or cooling operations of a facility, which may further constrain the techniques that can be employed for sludge extraction.

With this in mind, Applicants have recognized that, by using a vacuum-based sludge extraction technique, the material extraction assembly 10 can efficiently and effectively extract the sludge from the tank while avoiding the aforementioned issued of other removal techniques. Some embodiments disclosed herein may relate to assemblies, apparatuses, systems, and methods for extracting material from a storage site, such as, for example, removing undesired material from environments, such as, for example, industrial environments. For example, some embodiments disclosed herein may facilitate extraction of undesired materials from an industrial environment using, for example, a high-strength vacuum flow. Removing undesired material from an industrial environment using a high-strength vacuum flow may provide for time-efficient removal of the undesired materials and/or may reduce or prevent contamination of the ambient environment with the undesired material or portions thereof. Industrial environments, chemical reaction towers, and the associated material discussed herein are merely examples, and other types of environments and/or other types of materials are contemplated.

The Applicants further recognized various advantages and challenges associated with the vacuum-based sludge removal approach. For example, the Applicant recognized that the sludge can be removed via the open top of the elevated open storage tank 16 using the vacuum-based sludge extraction technique, which avoids potential damage to the tank that may be caused by cutting holes in the side of the tank to gain access to the sludge. However, the Applicant also recognized that the strength of the vacuum flow must be sufficiently high in order to motivate the sludge to flow against the force of gravity through a vacuum hose 26 that extends up through the open top of the tank. The Applicant also recognized that, as the sludge settles within the tank over time, the sludge layer at the bottom of the tank may increase in density and decrease in fluidity, which can increase the sludge's resistance to flowing through the vacuum hose 26. To address this challenge, the Applicant recognized that, by jetting additional water into the sludge during vacuum extraction, the density of the sludge may be reduced, and the fluidity of the sludge may be increased, thereby enabling the sludge to flow through the vacuum hose efficiently and effectively 26 during extraction.

As schematically depicted in FIGS. 1A-D, the material extraction assembly 10 and related methods, according to at least some embodiments, may facilitate extraction of material, such as the undesired material 12 from the elevated open storage tank 16 using one or more high-strength vacuum flows. The use of high-strength vacuum flows may facilitate extraction of the undesired material 12 (and/or other material), for example, in situations in which there is limited physical access to the interior of the elevated open storage tank 16, where the undesired material 12 may be present. The use of high-strength vacuum flows may facilitate parallel removal of the undesired material 12 from multiple locations (e.g., multiple elevated open storage tanks).

In some embodiments, the material extraction assembly 10 may be configured to efficiently extract the undesired material 12 through the open top of the elevated open storage tank 16, for example, by generating a high-strength vacuum flow that is delivered to the interior of the tank via the vacuum hose 26. In some embodiments, the high-strength vacuum flow may generate suction directed out of the interior of the elevated open storage tank 16 through the open top of the tank 16. The suction may generate a vacuum-induced vacuum flow 28, in which at least a portion of the undesired material 12 becomes entrained in the vacuum-induced vacuum flow 28 within the vacuum hose 26.

Applicant has recognized that the undesired material 12 may be heterogeneous in nature and/or may include material that ranges in size from nanometer scale to millimeter scale sediment particulates. The undesired material 12 may also be in various states of matter. For example, some portions of the undesired material 12 may be solid, and other portions may be liquid or semi-liquid. Conventional approaches to material removal may be unable to effectively extract and process heterogeneous undesired materials. In some embodiments, the material extraction assembly 10 may facilitate extraction of heterogeneous undesired material 12, for example, using the high-strength vacuum flow 28. In some embodiments, the high-strength vacuum flow 28 may be capable of moving a broad range of materials in various states of matter. The use of a high-strength vacuum flow 28 for material extraction may facilitate substantial containment of removed undesired material 12, thereby limiting or preventing release into or contamination of the ambient environment with portion of the extracted undesired material 12.

The example material extraction assembly 10 shown in FIGS. 1A-D may be used to extract undesired material 12 from various environments. While described with respect to an industrial environment, at least some embodiments may be used to remove undesired material 12 from other environments, including, for example, commercial, residential, and natural environments. In one such example, the example material extraction assembly 10 may be used to extract or harvest liquid, solid, and semi-solid materials from retention ponds (not shown) and other retention reservoirs for disposal. The retention reservoir may accumulate, for example, runoff, waste, pollutants, sediment, and other matter from higher elevation surfaces. Applicant has recognized that it may be desirable to rapidly convey materials in large quantities and/or in an efficient manner to desired locations, for example, which may present unique challenges. For example, it may be difficult to rapidly convey large quantities of undesired materials to an elevated position relative to a source or supply of the material. Although liquid materials may be pumped to elevated positions using conventional pumps, other types of materials, such as semi-solid materials, sludge, particulates, sand, gravel, and discrete solid materials of regular or irregular sizes and shapes may be difficult efficiently to convey to elevated locations.

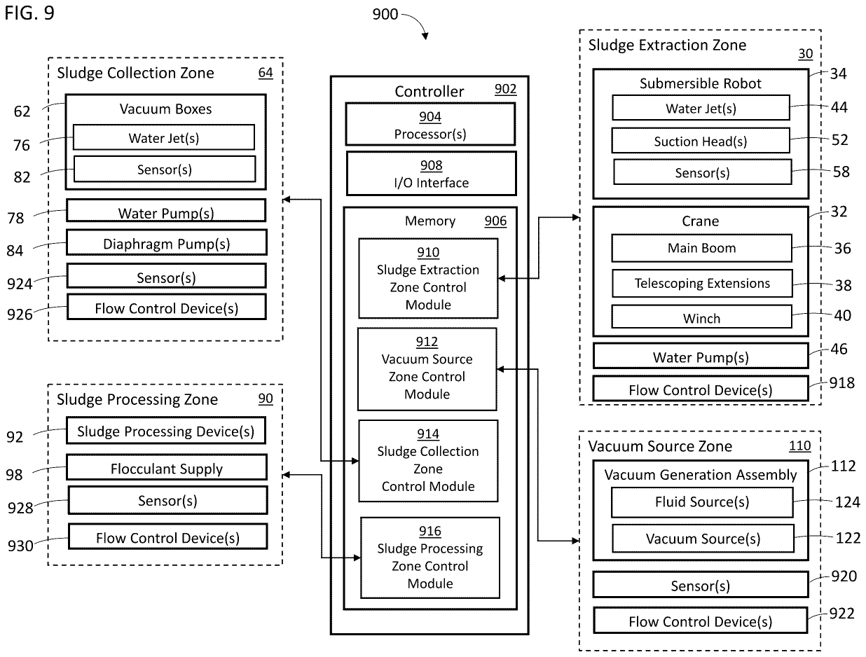

The embodiment of the material extraction assembly 10 illustrated in FIGS. 1A-1D includes a sludge extraction zone 30. The sludge extraction zone 30 includes a crane 32 that is positioned to lower and position a submersible robot 34 within the elevated open storage tank 16. In some embodiments, the crane 32 may include a main boom 36, one or more telescoping extensions 38, a winch 40, a cable 42, and/or other suitable features to facilitate positioning the submersible robot 34 within the elevated open storage tank 16 during sludge extraction. In some embodiments, the crane 32 may be equipped with various sensors, such as proximity sensors, to monitor the position of the crane 32 during vacuum extraction. In some embodiments, the crane 32 may be manually controlled by an operator, while in other embodiments, the crane 32 may be partially or completely controlled by a controller, as discussed below with respect to FIG. 9.

For the illustrated embodiment of the material extraction assembly 10, the submersible robot 34 of the sludge extraction zone 30 includes one or more water jets 44 fluidly connected to a water pump 46 via a high-pressure hose 48. The water pump 46 is fluidly connected to a water supply tank 50 that supplies water to the water pump 46. As discussed herein, at least a portion of the water provided from the water supply tank 50 may include water that was separated from extracted sludge during sludge processing. The submersible robot 34 includes at least one suction head 52 that is fluidly connected to the vacuum hose 26 to receive the high-strength vacuum flow 28. During operation, the water jets 44 direct one or more high-pressure water streams 54 into the sludge 18, thereby to decrease the density and increase the fluidity of the sludge, also referred to herein as fluidizing the sludge. The suction head 52 extracts the fluidized sludge 56 from the elevated open storage tank 16 and into the vacuum hose 26. In some embodiments, the vacuum hose 26 has a diameter of at least 6 inches to enable a suitable volume of sludge to be extracted per unit time of the sludge extraction operation. In some embodiments, the submersible robot 34 is equipped with various sensors 58, such as proximity sensors, pressure sensors, flow sensors, and/or other suitable sensors, to monitor the position and operation of the submersible robot 34 during a sludge extraction operation. In some embodiments, the submersible robot 34 may be manually controlled by an operator, while in other embodiments, the submersible robot 34 may be partially or completely controlled by a controller, as discussed below with respect to FIG. 9.

For the illustrated embodiment of the material extraction assembly 10, the fluidized sludge 56 extracted by the suction head 52 of the submersible robot 34 traverses the vacuum hose 26 as a result of the high-strength vacuum flow 28 and is deposited into a first upper inlet 60 of one or more vacuum boxes 62 (also referred to herein as material collectors) of a sludge collection zone 64. For example, as illustrated in FIG. 1B, in some embodiments, the fluidized sludge is introduced into a sludge collection manifold 66 that is fluidly connected between the vacuum hose 26 and a plurality of vacuum boxes 62, such that a portion of the extracted sludge is directed into each of the vacuum boxes 62. Embodiments that utilize multiple vacuum boxes 62 offers advantages in terms of the volume of sludge that can be collected within the sludge collection zone 64 prior to sludge processing, while also limiting the size of each of the vacuum boxes 62 to facilitate transport and installation. It may be appreciated that, while four vacuum boxes 62 arranged in parallel are present for the embodiment of the sludge collection zone 64 illustrated in FIG. 1B, in other embodiments, two or more of the vacuum boxes 62 may instead be fluidly connected in series. In other embodiments, the number of vacuum boxes 62 may be greater or fewer, for example, depending on the volume of sludge being collected, the sludge collection rate, the sludge processing rate, other relevant factors of the sludge extraction operation, or any combination of these factors. In some embodiments, the sludge collection manifold 66, the vacuum boxes 62, and/or the intervening hoses or pipes may be equipped with flow control mechanisms (e.g., flow control valves, shut off valves) that may be used, for example, to block or prevent sludge collection in one or more of the vacuum boxes, for example, to facilitate inspection, repair, or replacement of one or more of the vacuum boxes 62.

For the embodiment of the sludge collection zone 64 illustrated in FIG. 1B, a second upper outlet 68 of each of the vacuum boxes 62 is fluidly connected a vacuum manifold 70. As such, the vacuum boxes 62 are fluidly or pneumatically connected to both the sludge collection manifold 66 and the vacuum manifold 70. The vacuum manifold 70 may be fluidly or pneumatically connected to one or more vacuum generation assemblies of the vacuum source zone, as illustrated in FIG. 1D, to receive the vacuum flow 28 that motivates the extracted sludge to enter the vacuum boxes 62. Additionally, as illustrated in FIG. 1C, a lower outlet 72 of each of the vacuum boxes 62 is fluidly connected to a sludge processing manifold 74 that is configured to receive the collected sludge 18 from the vacuum boxes 62, as discussed herein. The Applicant recognized that, in some cases, the sludge collected within the vacuum boxes 62 can settle, again increasing the density and reducing the fluidity of the collected sludge 18. As such, in some embodiments, the vacuum boxes 62 are equipped with one or more water jets 76 fluidly connected to a water pump 78. The water pump 78 receives water from a fluidly connected water supply tank 80 and generates a pressurized stream of water that is then delivered to the water jets 76 of the vacuum boxes 62 to reduce the density and increase the fluidity of the collected sludge, enabling the re-fluidized sludge to be more easily flow from the vacuum boxes 62 and into the sludge processing manifold 74. In some embodiments, the vacuum boxes 62 are equipped with one or more sensors 82, such as fill sensors, sludge fluidization sensors, and/or any other sensors suitable for measuring a property of the collected sludge. In some embodiments, a controller may receive monitoring data from sensors associated with the vacuum boxes 62 and, in response, may provide control signals to control operation of various equipment (e.g., water pump 78, water jets 76, flow control mechanisms) associated with the vacuum boxes 62.

FIG. 1C illustrates a portion the material extraction assembly 10, including a portion of the sludge collection zone 64 and a sludge processing zone 90, in accordance with an example embodiment. The portion of the sludge collection zone 64 illustrated in FIG. 1C includes the sludge processing manifold 74 that is fluidly connected to the lower outlet 72 of each of the vacuum boxes 62. An outlet of the sludge processing manifold 74 is fluidly connected to a diaphragm pump 84, or another suitable pump, of the sludge collection zone 64 that is configured to pump the fluidized sludge 86 from the sludge collection manifold 66 and into one or more sludge processing devices 92 of a sludge processing zone 90. The one or more sludge processing devices 92 of the sludge processing zone 90 are configured to receive and process the sludge to separate the liquid water from the solid sediment. For the embodiment illustrated in FIG. 1C, sludge processing zone 90 includes a centrifuge as the sludge processing device 92, which utilizes centrifugal force to process the received sludge to recover water 94 and sediment 96. The recovered water 94 may be substantially or entirely free of sediment particulates, but may still include one or more water-soluble components (e.g., dissolved salts, acids, bases) and/or liquid components (e.g., oils).

In some embodiments, multiple sludge processing devices 92 may be used, in parallel or in series, to process the fluidized sludge 86. In some embodiments, the one or more sludge processing devices 92 may include centrifuges, shakers, desanders, desilters, other solid-liquid separation units, or any combination of these. In some embodiments, the sludge processing zone 90 includes a flocculant supply 98 configured to provide one or more flocculants 100 that is combined with the fluidized sludge 86 either prior to or during sludge processing to facilitate the separation of the water 94 from the sediment 96. The recovered water 94 separated by the one or more sludge processing devices 92 is directed to a water supply tank 102, which may be the same as the water supply tank 50 and/or the water supply tank 80 illustrated in FIGS. 1A and 1B in some embodiments, or may be in fluid communication with the water supply tanks 50 and/or 80 in some embodiments. As such, the recovered water 94 may be recycled for use in the sludge extraction zone 30 and/or sludge collection zone 64, as discussed above, advantageously limiting the water consumption of the material extraction assembly 10. The recovered sediment 96 may be conveyed to a sediment storage vessel 104, such as another elevated open storage tank, for storage or disposal.

FIG. 1D illustrates an embodiment of a vacuum source zone 110 of the material extraction assembly 10. For the illustrated embodiment, the vacuum source zone 110 includes one or more vacuum generation assemblies that are fluidly or pneumatically connected to the vacuum manifold 70 of the sludge collection zone 64 illustrated in FIG. 1B to provide the vacuum flow to facilitate sludge collection. While a single vacuum generation assembly 112 is illustrated in FIG. 1D, the vacuum source zone 110 may include any suitable number of vacuum generation assemblies (e.g., 2, 3, 4, 5, or more) to provide a vacuum flow having a suitably high strength (e.g., sufficiently low pressure) and a suitable vacuum flow rate to enable effective sludge extraction within the sludge extraction zone 30 and effective sludge collection within the sludge collection zone 64. In some embodiments, the strength and flow rate of the vacuum flow 28 used to facilitate sludge collection may depend on different factors, such as the height 20 of the elevated open storage tank 16, a diameter of the vacuum hose 26, a density of the fluidized sludge being extracted, a desired sludge collection rate, and/or other relevant factors. For example, in some embodiments, the pressure generated by the one or more vacuum generation assemblies may range from about from about 400,000 Pascals to about 900,000 Pascals to generate the vacuum flow. In some embodiments, the vacuum flow rate may range from about 200 cubic feet per minute (ft³/min) to about 800 ft³/min at 100 pounds per square inch (PSI). In some implementations, each vacuum generation assembly 112 of the vacuum source zone 110 may generate a vacuum flow having a pressure ranging from about from about 600,000 Pascals to about 700,000 Pascals and a vacuum flow rate may range from about 400 ft³/min to about 600 ft³/min at 100 PSI.

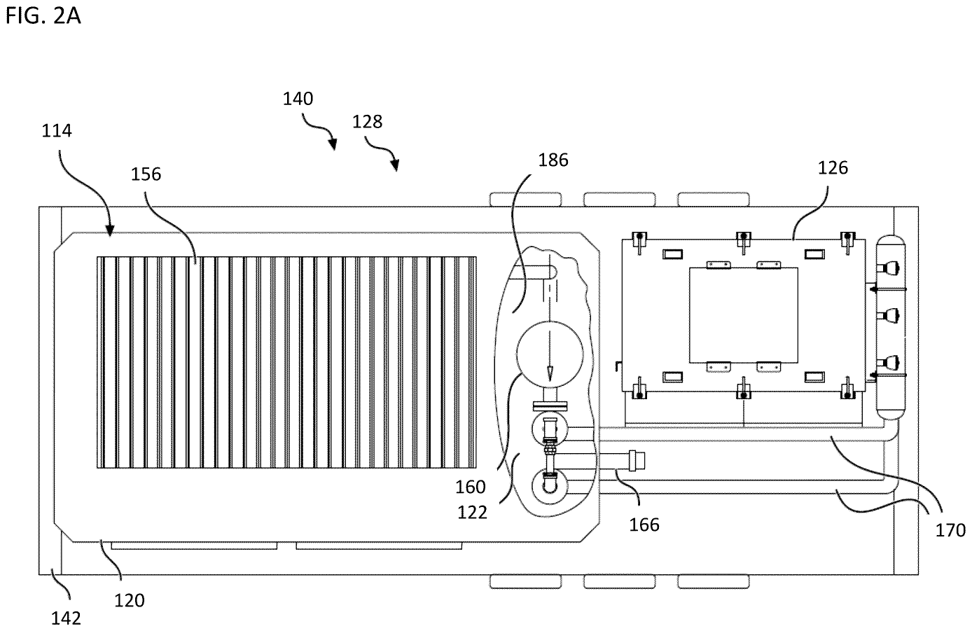

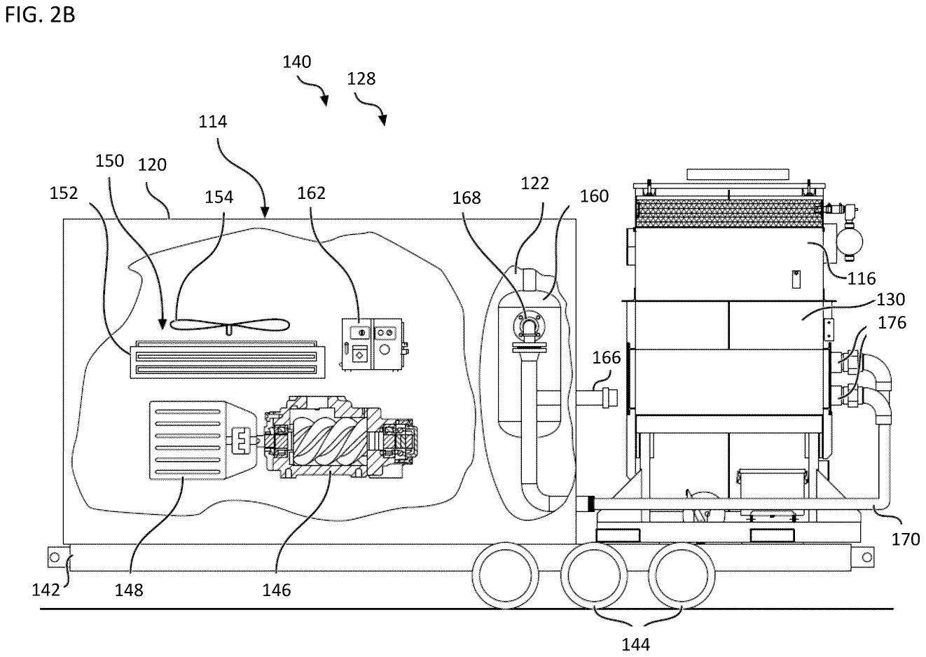

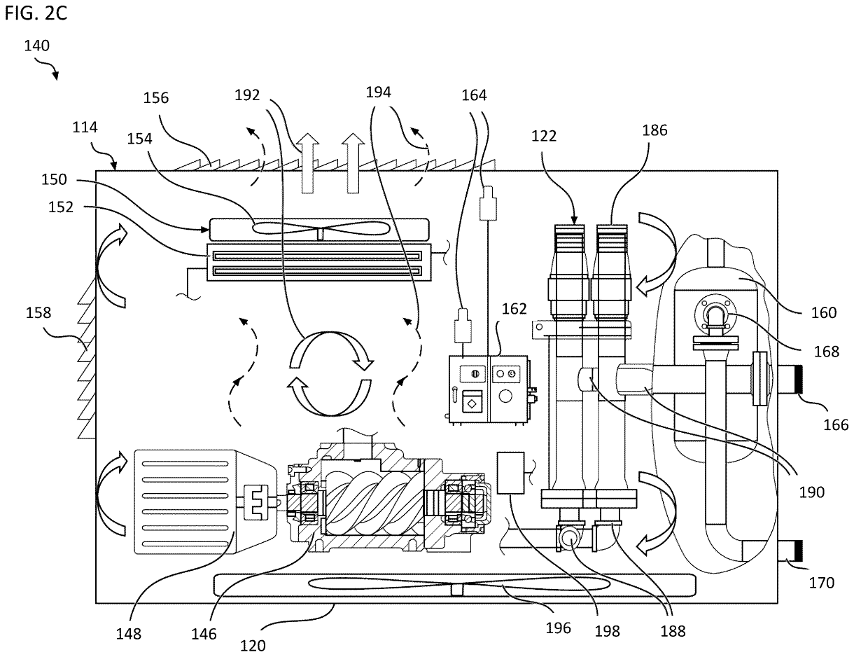

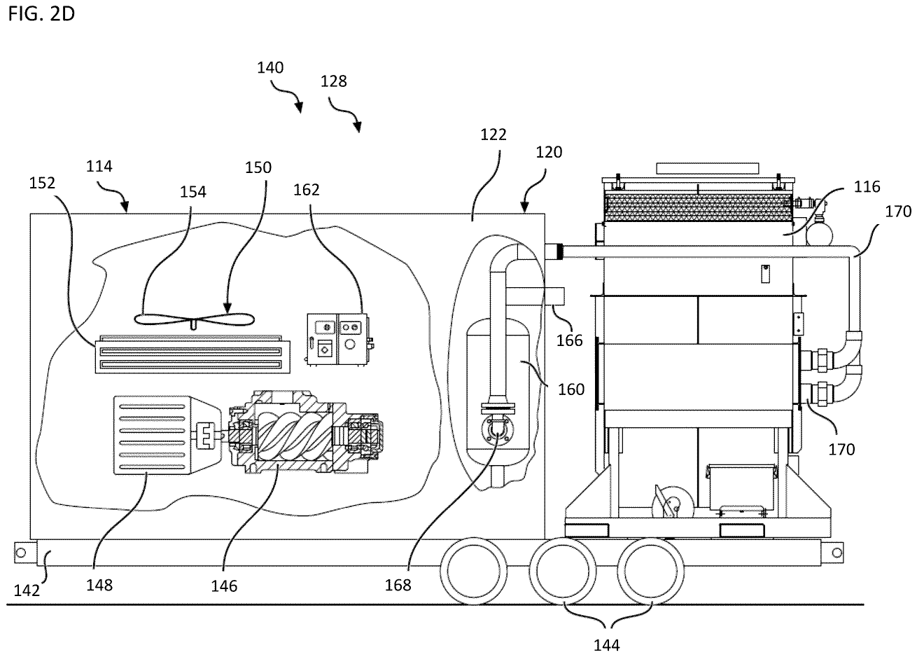

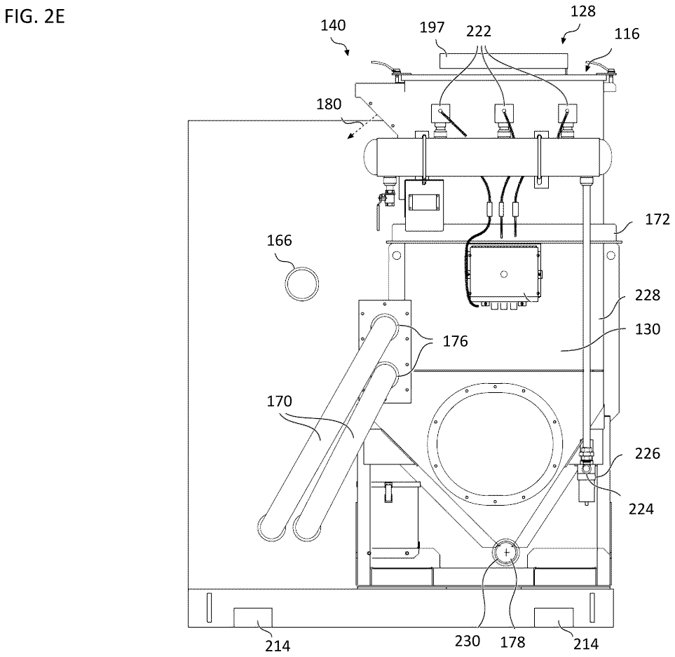

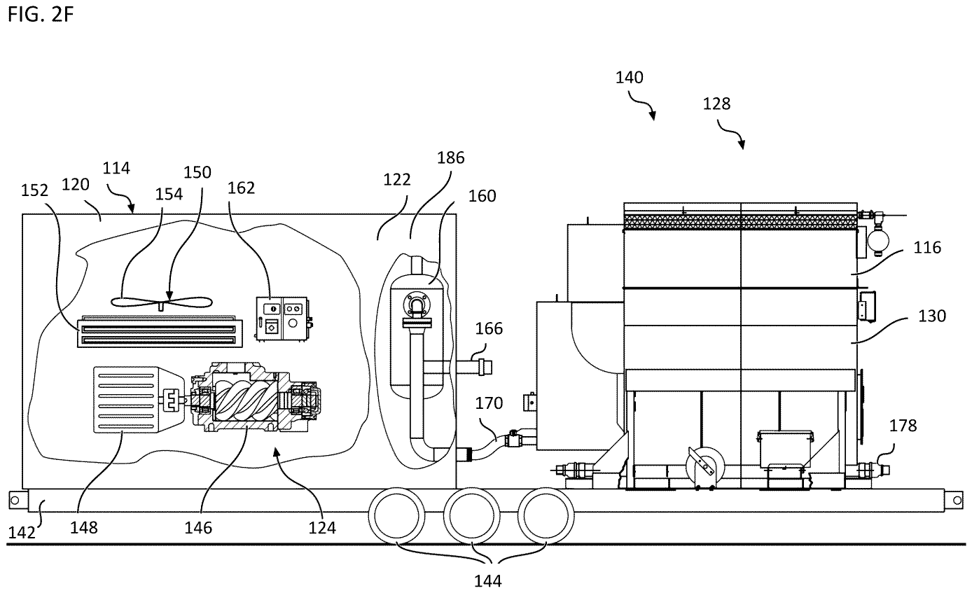

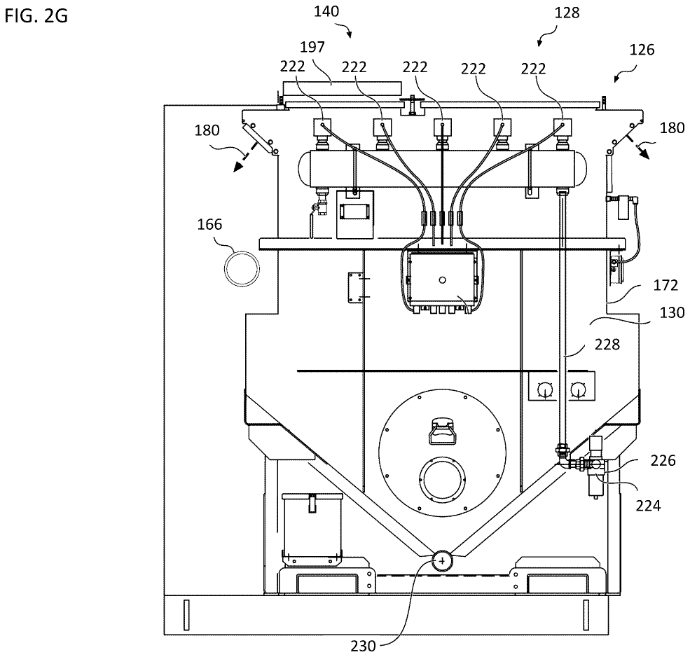

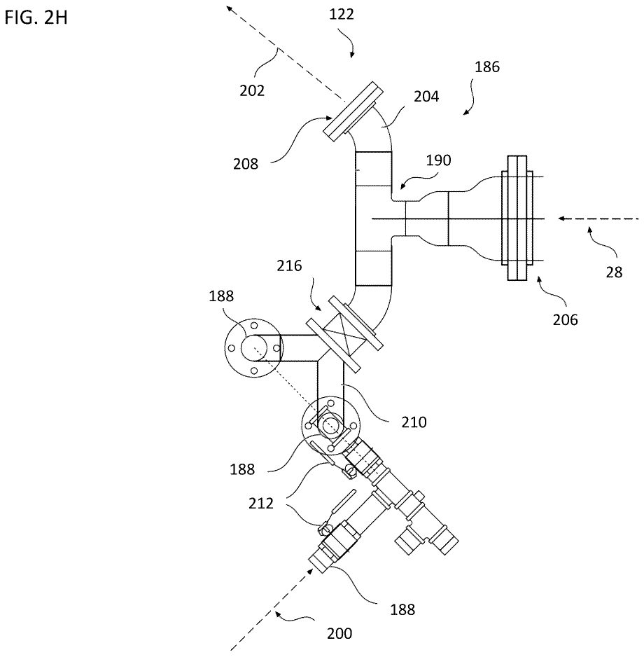

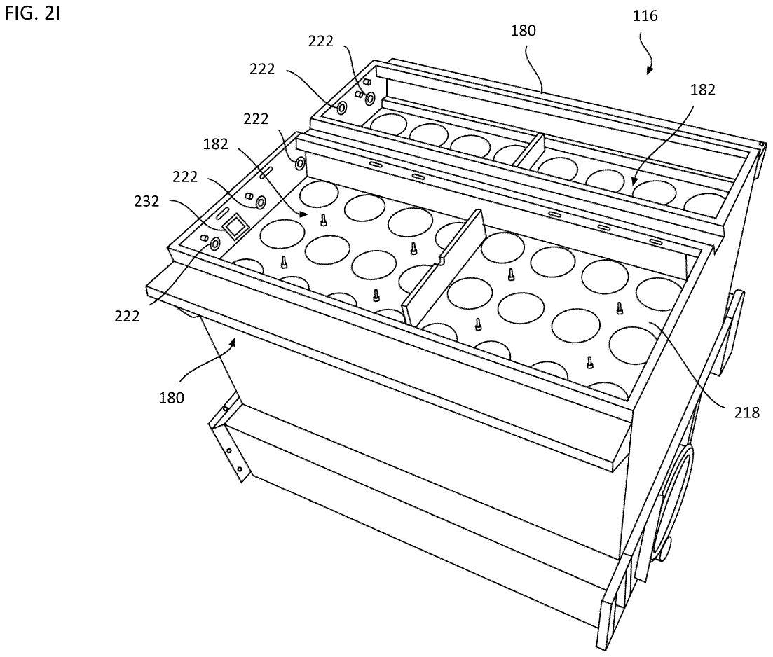

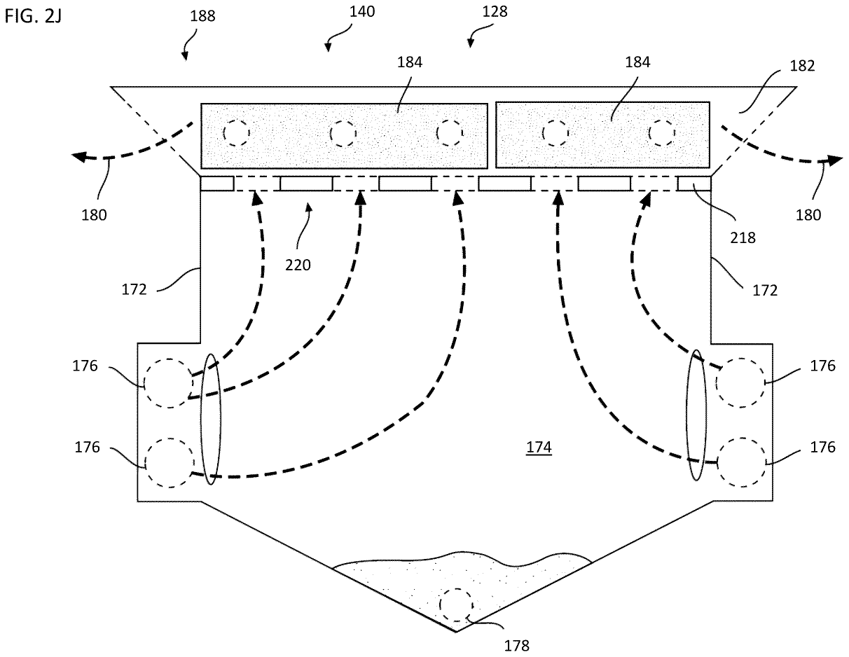

For the embodiment illustrated in FIG. 1D, the vacuum generation assembly 112 includes a compressor and vacuum source assembly 114, a sound attenuating chamber 116 connected to the compressor and vacuum source assembly 114 and the one or more vacuum boxes 62 via the conduit 118. The compressor and vacuum source assembly 114 may include a compressor housing 120 containing at least a vacuum source 122 and a fluid source 124. The fluid source 124 may be, for example, a compressor or other device configured to provide pressurized fluid to the vacuum source 122. In some embodiments, one or more of the vacuum boxes 62, the compressor and vacuum source assembly 114 containing the vacuum source 122 and the fluid source 124, or the sound attenuation chamber 126 may be configured to be easily transported between geographical locations for use at different environments. Packaging multiple pieces of the compressor and vacuum source assembly 114, such as the vacuum source 122, fluid source 124, and other components (see, e.g., FIG. 2A-FIG. 2F) together within the compressor housing 120 may allow the material extraction assembly 10 to have a more compact footprint. A smaller footprint may allow the material extraction assembly 10 to, for example, be supported on one or more trailers including wheels, tracks, skids, or other devices for facilitating movement between geographical locations, and to occupy less space at those locations.

In some embodiments, one or more of the vacuum boxes 62, the compressor and vacuum source assembly 114, or the sound attenuation chamber 126 may be arranged to form a flow path beginning at the elevated open storage tank 16 (e.g., the suction head 52 of the submersible robot 34) and terminating at the sound attenuation chamber 126. The flow path may be used to extract undesired material 12 from the elevated open storage tank 16 and, in some embodiments, limit contamination of the ambient environment. For example, the vacuum source 122 may generate a vacuum in the flow path, thereby generating a fluid flow along the flow path. The fluid flow may be used to apply suction proximate the undesired material 12 in the elevated open storage tank 16 to draw the undesired material 12 into the flow path. The fluid flow in the flow path may cause the undesired material 12 to flow out of the elevated open storage tank 16 and into the one or more vacuum boxes 62, thereby separating at least a portion of the undesired material 12 from the environment. In some embodiments, a major portion of the undesired material 12 may be deposited in the one or more vacuum boxes 62. In some embodiments, a minor portion of the undesired material 12 may flow from the one or more vacuum boxes 62, through the vacuum source 122, and into the sound attenuation chamber 126. In some embodiments, the sound attenuation chamber 126 may be configured to remove (or reduce) the minor portion of the undesired material 12 in the fluid flow prior to the fluid flow being exhausted into the ambient environment.

In some embodiments, to form the flow path, the vacuum boxes 62 may be pneumatically connected to the source or storage of the undesired material (e.g., the elevated open storage tank 16). In some embodiments, the pneumatic connection between the suction head 52 of the submersible robot 34 and the vacuum boxes 62 may be formed using the sludge collection manifold 66 and/or the vacuum hose 26. For example, the sludge collection manifold 66 may be connected to one or more vacuum boxes 62, as shown in the example in FIG. 1B. In some embodiments, the sludge collection manifold 66 may be connected to different submersible robots positioned within the same elevated open storage tank 16 or different elevated open storage tanks, thereby pneumatically connecting the vacuum boxes 62 to receive undesired material 12 from one or more elevated open storage tanks. Pneumatically connecting the vacuum boxes 62 to a single submersible robot 34 positioned within an elevated open storage tank 16 may direct the full suction force along a single flow path. Alternatively, pneumatically connecting the vacuum boxes 62 to multiple submersible robots may facilitate extraction of undesired material 12 from each of the one or more elevated open storage tanks, for example, concurrently, simultaneously, sequentially, and in parallel, among others.

As noted, some elevated open storage tanks 16 may be tall. In some embodiments, the vacuum hose 26 may include relatively rigid piping (e.g., poly pipe or polyethylene pipe). The vacuum hose 26 may be at least partially self-supporting, which may facilitate pneumatic connection between the vacuum boxes 62 and the suction head 52 of the submersible robot 34. The piping may be of low weight and/or easily attachable to a wide variety of structures, which may reduce the need for significant in-person access to inaccessible or difficult-to-reach locations within the elevated open storage tank 16 to extract undesired material 12. In some embodiments, the vacuum hose 26 may be flexible to allow for pneumatic connection between the vacuum boxes 62 and the submersible robot 34 in various orientations and positions with respect to one another. The vacuum hose 26 may be sized so as not to limit the flow of undesired material 12 along the flow path. In some embodiments, the vacuum hose 26 and/or the sludge collection manifold 66 may be pneumatically connected to a single vacuum box. In some embodiments, the sludge collection manifold 66 may be connected to multiple vacuum boxes 62, and/or multiple sludge collection manifolds may be connected to one or more vacuum boxes 62. In some embodiments, the multiple vacuum boxes 62 may be connected in parallel to, for example, scale-up the extraction capacity of the material extraction assembly 10.

In some embodiments, the undesired material 12 may flow into the vacuum boxes 62 after flowing through the vacuum hose 26 and the sludge collection manifold 66. A major portion of the undesired material 12 may be collected in the one or more vacuum boxes 62. In some embodiments, however, some (e.g., a minor portion) of the undesired material 12 may flow out of the one or more vacuum boxes 62 in the flow path of the high-strength vacuum flow 28 through one or more conduits connected to the second upper outlet 68 of the vacuum boxes. In some embodiments, the vacuum boxes 62 may remove a major portion of the undesired material 12 from the fluid flow it receives along the flow path of the vacuum flow 28. In some embodiments, the vacuum boxes 62 may receive all, or a portion, of the fluid flow out of the elevated open storage tank 16, and the vacuum boxes 62 may include one or more structures configured to trap a major portion of the undesired material 12 in the fluid flow received inside the vacuum boxes 62. In some embodiments, the major portion of the undesired material 12 may be retained in the vacuum boxes 62, for example, for disposal, recycling, and/or remediation.

FIGS. 1D, 2A, 2B, 2C, 2D, 2E, 2F, and 2G are schematic views of example vacuum generation and sound attenuation assemblies 128 according to embodiments of the disclosure. In some embodiments, the vacuum generation and sound attenuation assembly 128 may include a sound attenuation chamber 126 connected to the vacuum source 122. In some embodiments, the sound attenuation chamber 126 may include an attenuation housing 130 at least partially defining a chamber interior volume being positioned to receive at least a portion of the vacuum flow 28 from the vacuum source 122 and attenuate sound generated by the vacuum source 122 during operation. In some embodiments of the vacuum generation and sound attenuation assembly 128, the vacuum source 122 and the sound attenuation chamber 126 may be connected to one another to form a unified vacuum and attenuation module 140. In some embodiments, the vacuum source 122 may be directly connected to the sound attenuation chamber 126. In the example embodiment shown, the unified vacuum and attenuation module 140 includes a chassis 142 supporting the vacuum source 122 and the sound attenuation chamber 126, and the chassis 142 may be configured to be transported between geographic locations. The chassis 142 may have wheels 144 for ease of transport and may also have lift lugs or other hard points for rigging operations, so as to be easily relocated and deployed by operators of the site using a crane, forklift, or other appropriate equipment and/or methods. In some embodiments, wheels 144 may be connected to the chassis 142 to facilitate transportation, although tracks, skids, etc., may be connected to the chassis 142 instead of, or in addition to, wheels 144, depending, for example, on the type of terrain over which the vacuum and attenuation module 140 may be expected to traverse. In some embodiments, the chassis 142 may be self-propelled, for example, including a powertrain having an engine, hydraulic motor, and/or electric motor. Mounting the vacuum and attenuation module 140 on a mobile chassis 142 may facilitate rapid set-up, removal, and/or reconfiguration of the material extraction assembly 10 in accordance with embodiments of the disclosure.

FIG. 2A is a schematic top view and FIG. 2B is a schematic side view of an example vacuum generation and sound attenuation assembly 128 according to embodiments of the disclosure. The compressor housing 120 of a compressor and vacuum source assembly 114 may include components utilized to generate, manage, and/or control the vacuum flow. The compressor housing 120 may include, for example, a hollow interior with an equipment pad for the components and access points for operators of the site to monitor and service the equipment. In some embodiments, one or more doors may be provided on compressor housing 120 to permit access, service, and/or replace components contained in the compressor housing 120.

In some examples, the compressor and vacuum source assembly 114 may include a fluid source including one or more compressors 146 powered by one or more motors 148 within the compressor housing 120. The one or more compressors 146 may be used to generate a supply of pressurized fluid to provide the vacuum source 122. The one or more compressors 146 may include, for example, a positive displacement rotary screw compressor sized to provide efficient flow of pressurized fluid over extended run duty cycles, although other compressor types are contemplated. A rotary screw compressor may, for example, have a pair of continuously rotating asymmetric screws to increase the pressure of a working fluid (e.g., air) in a chamber. Operating speeds of the compressor 146 may be varied to meet the vacuum flow requirements of applications. Applicant has also recognized that the comparatively smooth and quiet operation of a rotary screw compressor may eliminate the need for a specialized foundation or mounting system (for example, a vibration-absorbing base, isolation mount, or others) to maintain a smaller sized footprint in the compressor housing 120. The one or more compressors 146 may also be powered by one or more prime movers, such as, for example, electric motors 148 suitable for compact and portable operation. For example, the one or more compressors 146 and/or the one or more electric motors 148 may be configured to provide a flow rate of 500 or more cubic feet per minute (cfm), 600 or more cfm, 700 or more cfm, 800 or more cfm, 900 or more cfm, or 1,000 or more cfm, for example, at a pressure of 50 or more pounds per square inch (psig), 60 or more psig, 70 or more psig, 80 or more psig, 90 or more psig, or 100 or more psig.

In some embodiments, the compressor housing 120 may contain other components of the fluid source 124 supporting the operation of the one or more compressors 146. For example, a cooling system 150 may be configured to remove generated heat from the interior of the compressor housing 120. The cooling system 150 may include, for example, one or more after coolers 152. The after coolers 152 may include a heat exchanger to extract heat from the compressed air flow from the compressor 146. In some examples, the one or more after coolers 152 may include one or more heat exchange surfaces (e.g., a plurality of baffles or fins) to distribute heat more evenly. One or more fans 154 may be provided to draw waste heat from the after cooler 152 and force the heat out of the compressor housing 120 through one or more vents 156 in the housing. In some embodiments, the one or more vents 156 (e.g., two or four vents) may be provided in the roof of the compressor housing 120, for example, as shown in FIG. 2A. Alternatively, or in addition, secondary vents 158 may be provided in or on the sides of the compressor housing, for example, as shown in FIG. 2C. The size and/or number of vents 156 may be configured to provide sufficient entry of air from the surroundings for feeding the compressor 146 and/or to provide sufficient cooling for operation of the one or more electric motors 148 and/or the one or more compressors 146. In some embodiments, one or more vents 156 may be provided with louvers and/or a system to prevent dust, debris, and/or water (e.g., rain) from entering through the roof of the compressor housing 120. In some embodiments, the air with condensed moisture from the after cooler 152 may subsequently enter a moisture separator 160 where the air is caused to circulate around the separator body to separate and collect droplets of moisture from the air at the base of the separator by gravity.

In some embodiments, the compressor and vacuum source assembly 114 may include a vacuum controller 162 within the compressor housing 120, so that operational set points may be controlled during operation (i.e., during continuous conveyance and/or extraction operations when the undesired material 12 may not be visible along at least portions of the flow path defined by the high-strength vacuum flow 28). The vacuum controller 162 may be used to control various operating parameters in the compressor housing 120, such as motor speed and torque of the electric motor 148, or the volumetric flow rate and supply pressure of the compressor 146.

To control various operating parameters in the compressor housing 120, the vacuum controller 162 may obtain information from one or more sensors 164 (see FIG. 2C) in the housing that monitor operational conditions and provide feedback for the vacuum controller 162. For example, the one or more sensors 164 may be positioned at various locations and may be operably connected to the vacuum controller 162 (e.g., in communication with the vacuum controller 162). The one or more sensors 164 may be configured to generate signals indicative of one or more physical and/or environmental properties, communicating the signals to the vacuum controller 162, and/or displaying information relating to the properties (or quantities) determined from the measured physical properties, such as, for example, flow rates, pressures, vapor pressures, moisture levels, temperatures, rotational speeds, and other parameters known in the art.

The vacuum controller 162 may be in communication with and control one or more valves through the compressor and vacuum source assembly 114. The valves may include, but are not limited to, intake valves, blow down valves, thermal valves, minimum pressure valves, pressure relief valves, or solenoid valves, among others. The vacuum controller 162 may control the one or more valves to adjust or tune operation of the compressor and vacuum source assembly 114. For example, the strength of the vacuum flow 28 generated by the vacuum source 122 may be, for example, substantially proportional to the position of valves controlling a flow rate, pressure, and/or volume of fluid flow from the one or more compressors 146. In addition, the vacuum controller 162 may detect lower volumetric flow rates (for example, 100 cfm or less) and/or pressures during an initial startup of the vacuum source 122 and adjust parameters as necessary to ramp up to a desired flow rate. For example, the one or more electric motors 148 may be variable speed motors, and the vacuum controller 162 may set the amperage for the electric motors 148 during ramp up to prevent current surges which could otherwise trigger fuses or circuit breakers. In another example, the vacuum controller 162 may increase the amperage supplied to the electric motors 148 to prevent a stall in the event measured supply pressures drop below threshold levels during the ramp up.

In some embodiments, the vacuum controller 162 may include computing hardware (e.g., processors, memory, storage devices, communication devices, other types of hardware devices including circuitry, etc.) and/or computing instructions (e.g., computer code) that when executed by the computing hardware cause the vacuum controller 162 to provide its functionality. The vacuum controller 162 may include a lookup table or other data structure usable to determine the setpoint levels to, for example, efficiently extract material from one or more elevated open storage tanks 16.

In some embodiments, a user input device may be provided in communication with the vacuum controller 162. The user input may be communicated to the vacuum controller 162 via the user input device. The user input device may include, for example, one or more buttons, touch sensitive displays, levers, knobs, and/or other devices (e.g., control panels, tablet computers, and/or smart phones) that are operable by personnel to provide the vacuum controller 162 with information for operating and controlling the vacuum flow.

The compressor housing 120 may have ports, unions, and/or other fittings as a junction for fluidic communication between, for example, the vacuum source 122 of the compressor and vacuum source assembly 114, the one or more vacuum boxes 62, the suction head 52 of the submersible robot 34 (see, e.g., FIGS. 1A-D). To transfer the undesired material 12 from the elevated open storage tank 16 to the vacuum boxes 62, as shown in FIG. 1A, a high-strength vacuum flow 28 may be applied to the vacuum boxes 62. The high-strength vacuum flow 28 may be transferred to the vacuum boxes 62 through one or more suction outlet ports 166. In some embodiments, the one or more suction outlet ports 166 may be a 4-inch diameter coupling, although other sizes and configurations of suction outlet ports 166 are contemplated. For example, the vacuum flow 28 may be applied to the interior of the vacuum boxes 62 via the conduit 118 (or through other types of pneumatic connections between the components). The applied vacuum flow 28 may generate the vacuum-induced fluid flow 28 along the flow path, thereby conveying the undesired material 12 from elevated open storage tank 16 to the one or more vacuum boxes 62.

The compressor housing 120 may have, for example, one or more exhaust outlet ports 168 for the delivery of at least some of the vacuum flow to the sound attenuation chamber 126. Exhaust flow paths 170 of manifolds or ducts may be used to provide a flow path for the exhaust of the vacuum flow to inlet ports 176 of the sound attenuation chamber 126. The sound attenuation chamber 126 may have alternate configurations and sizes, such as that shown in FIGS. 2F and 2G.

FIG. 2C illustrates an example of components of the compressor and vacuum source assembly 114 within the compressor housing 120. In an enclosed or semi-enclosed environment, there may be a high likelihood of generating thermal energy and accumulating moisture. Routing of the exhaust flows, and the expulsion of heat and moisture produced by generating a vacuum flow from the supply of compressed fluid from a compressor, may be important design considerations in industrial vacuum applications. While some amounts of heat and moisture may be anticipated for these applications, accumulation may be costly in terms of maintenance and machinery downtime, which may also hinder productivity.

As shown in FIG. 2C, a compact arrangement of components to maintain spacing within the confines of the compressor housing 120 provides a pattern of circulation and venting to rid the environment of heat and moisture that may be detrimental to the service life of a compressor 146. Applicant has found a space-saving layout of the vacuum generators 186 of the vacuum source 122 with respect to fluid supply ports 188 for flow of the pressurized fluid from the one or more compressors 146 and exhaust flow paths 170. For example, fluid supply ports 188 and/or associated supply valves for the venturi mechanisms 190 or the vacuum source 122 may enable smaller, more compact compressors 146 to be utilized. The additional free volume within the compressor housing 120 may allow for, for example, better circulation of exhaust heated airflows and moisture flows 192, 194 within the housing for more efficient cooling and venting than would be possible with other vacuum-generating assemblies.

Additionally, the elevation positioning of the exhaust flow paths 170 from the vacuum generators relative to the one or more suction outlet ports 166 may improve efficiency of the compressor and vacuum source assembly 114. For example, locating the exhaust flow paths 170 to a higher elevation within the compressor housing 120 (see, e.g., locations in FIG. 2D relative to FIG. 2C) relative to the venturi mechanisms 190 and suction outlet ports 166 may allow more effective outflow of exhaust and the use of what may otherwise be unused space within the compressor housing 120. As an alternative, the exhaust flow paths 170 may occupy an elevated position on an opposite sidewall of the compressor housing 120. The exhaust flow paths 170 may additionally include openings or vents to eliminate back-pressure.

In some embodiments, the compressor and vacuum source assembly 114 may include a recirculation fan 196 within the compressor housing 120 to distribute and exhaust heated airflows 192 and moisture flows 194 generated by the compression and vacuum generation processes. The recirculation fan 196 may rotate at variable speeds, such that there is sufficient airflow and aeration within the interior volume of the compressor housing 120. As illustrated in FIG. 2C, the recirculation fan 196 may be positioned at a lower elevation in the compressor housing 120 relative to the one or more compressors 146 and the vacuum source 122. From this position, the recirculation fan 196 may direct airflow up and around these components and promote exhaust heated airflows 192 and excess moisture flows 194 to leave the compressor housing 120 through one or more vents 156, for example, in the roof of the compressor housing 120. As an alternative, the recirculation fan 196 may be positioned at a higher elevation in the compressor housing 120 relative to the one or more compressors 146 and the vacuum source 122 (e.g., near the roof of the housing) to draw air and moisture flows up to exit through the roof. These more central locations for the recirculation fan 196 above or below the compressors 146 and the vacuum source 122 may allow for the layout and size of other components of the compressor and vacuum source assembly 114 to be shorter and more compact relative to a recirculation fan positioned, for example, at either end of the compressor housing 120 and directing flows laterally to exit one or more vents on a side of the compressor housing 120. In addition, the vents 156 may have, for example, features such as angled fins or louvres to protect the compressor and vacuum source assembly 114 from rain, dust, and/or other contaminants external to the compressor housing 120.

In some embodiments, the size and orientation of the vacuum source 122 of the compressor and vacuum source assembly 114 may allow for the suction and exhaust from the source to be directed in different directions. For example, the one or more suction outlet ports 166 and exhaust outlet ports 168 may be positioned in a substantially lower location in the compressor housing 120, as shown in FIG. 2B, as compared to the substantially elevated location shown in FIG. 2D. Additionally, the one or more suction outlet ports 166 may be positioned at substantially different elevations within the compressor housing 120 than the elevation of the one or more exhaust outlet ports 168. For example, the one or more suction outlet ports 166 may be positioned at an elevation higher than that of the one or more exhaust outlet ports 168. Alternatively, the one or more exhaust outlet ports 168 may be positioned at a higher elevation within the housing relative to the one or more suction outlet ports 166 to use what may otherwise be unused space in the compressor housing 120. Altering the orientation and configuration of the vacuum source 122 may provide a more compact and/or efficient arrangement of the vacuum source 122 (or other components) within the compressor housing 120. Generating the suction for the high-strength vacuum flow 28 in lower portions of the compressor housing 120, for example, may save additional space within the compressor housing 120 for the circulation and venting of airflow and moisture. In addition, generating the suction for the high-strength vacuum flow 28 in lower portions of the compressor housing 120, for example, may save additional space for the compressor and vacuum source assembly 114 on the mobile chassis 142.

In some embodiments, the vacuum controller 162 may be in communication with one or more sensors 164 (see FIG. 2C) within the compressor housing 120 that monitor operational conditions and provide feedback for the controller. The vacuum controller 162, for example, may be configured to receive signals and/or remote triggers from the sensors 164. In some examples, the sensors may include one or more thermocouples to measure component surface temperatures, the temperature of exhaust heated airflows 192 circulating within the housing, and/or other temperatures of significance. In response to one or more thermocouple signal(s), the vacuum controller 162 may for example, initiate operation, or increase the rotational speed, of the recirculation fan 196. Alternatively, in response to one or more thermocouple signal(s), the vacuum controller 162 may for example, increase the flow rate through the one or more after coolers 152 of the cooling system 150.

The compressor and vacuum source assembly 114 may also have an air dryer 198 within the compressor housing 120 to remove at least some of the moisture from the flow of compressed fluid. An air dryer 198 may also serve to supplement filters and/or water traps within the assembly. An air dryer 198 may have added benefits in some applications where elevated moisture levels in the environment (for example, from condensate, suspended water vapor, and other sources) may affect the quality of operations. One or more of the sensors 164 in the compressor housing 120 may be moisture sensors in communication with the vacuum controller 162. In response to one or more signals from the moisture sensors, the vacuum controller 162 may for example, issue commands to initiate operation, or increase the rotational speed, of the recirculation fan 196 to expel moisture flows 194 in the environment from the vents 156.

In some embodiments, the vacuum source 122 may be implemented using a variety of configurations, depending, for example, on the environment to which the one or more vacuum boxes 62 are deployed for operation. For example, in some embodiments, the vacuum source 122 may generate a vacuum, which may be applied to the vacuum boxes 62. For example, the vacuum source 122 may include one or more vacuum generators 186 configured to generate the vacuum flow 28, and the vacuum generators 186 may be pneumatically connected to one or more vacuum boxes 62, for example, via a conduit 118. In some examples, the one or more vacuum generators 186 may receive at least some electrical power via renewable means, such as batteries, solar panels 197, wind turbines, and/or other similar sources.

The one or more vacuum generators 186 may be configured to generate the vacuum flow 28 in different ways, depending at least in part on, for example, the environment to which the vacuum and attenuation module 140 is deployed. For example, in some embodiments, the vacuum generators 186 may be configured to generate the vacuum flow 28 using the flow of another fluid. For example, the vacuum generators 186 may be connected to a fluid source 124 (for example, the compressor 146). The flow of the pressurized fluid may cause the vacuum generators 186 to generate a high-strength vacuum flow 28, thereby applying a high-strength vacuum flow 28 to one or more vacuum boxes 62, which may, in turn, transfer the vacuum flow 28 from the one or more vacuum boxes 62 to the vacuum source 122. The vacuum-induced fluid flow 28 received from the one or more vacuum boxes 62 may include a minor portion of the undesired material 12 from the one or more vacuum boxes 62, for example, as described herein.

When the one or more vacuum generators 186 generate the vacuum flow 28, in some embodiments, the vacuum generators 186 may combine vacuum-induced flow 28 and a fluid supply flow 200 and exhaust the combined flows as a vacuum exhaust fluid flow 202, which may include the minor portion of the undesired material 12, for example, as schematically shown in FIG. 2H. To limit or prevent contamination of the ambient environment with the minor portion of the undesired material 12, the vacuum generators 186 may be pneumatically connected to the sound attenuation chamber 126 via a conduit 204 (e.g., a hose). The vacuum exhaust fluid flow 202 may flow from the vacuum source 122 into the sound attenuation chamber 126 via the conduit 204. Accordingly, the vacuum source 122 may be in the fluid flow path from the submersible robot 34 to sound attenuation chamber 126.

In some embodiments, in order to generate a more powerful high-strength vacuum flow 28, multiple vacuum sources 122 and/or one or more sound attenuation chambers 126 may be positioned on a common chassis 142 to form a more powerful vacuum generation and sound attenuation assembly 128 (e.g., a more powerful unified vacuum and attenuation module 140). For example, multiple vacuum sources 122 may each be pneumatically connected to the (one or more) sound attenuation chambers 126, which may cause two (or more) separate flow paths (e.g., for each of the vacuum sources 122) and which may be combined at the one or more sound attenuation chambers 126. In some embodiments, the vacuum sources 122 may be pneumatically connected to a common set of one or more vacuum boxes 62 (e.g., to increase the strength of the high-strength vacuum flow 28 through the common set of one or more vacuum boxes 62) or different vacuum boxes 62 (e.g., to enable the undesired material 12 to be transferred to multiple vacuum boxes 62 in parallel).

In some embodiments, the vacuum source 122 may be implemented using a variety of different structures, depending at least in part on, for example, the environment to which vacuum source 122 is deployed. For example, in some embodiments, the vacuum source 122 may include one or more vacuum generators 186, each having a venturi mechanism 190 configured to receive pressurized fluid from the fluid source 124 (for example, the compressor 146) and use a venturi effect to generate the vacuum flow 28 between the elevated open storage tank 16 and the vacuum generation and sound attenuation assembly 128. For example, the venturi mechanism 190 may be a vacuum generation mechanism that generates a vacuum using another fluid flow.

In some embodiments, the pressurized fluid supplied by the fluid source 124 to the vacuum generators 186 to generate a high-strength vacuum flow 28 may have a nominal velocity and a nominal pressure. The pressurized fluid may be directed along a flow path and passed through a restriction in the venturi mechanism 190, constricting the flow of the pressurized fluid and increasing its velocity. The increased velocity of the at least partially choked flow may cause a considerable reduction in the pressure and the drawing of a partial vacuum in that section of the flow path. The high-strength vacuum flow 28 may thus be generated reliably without any moving parts in the venturi mechanism 190 itself. Leveraging this phenomenon may increase the capacity and performance of the high-strength vacuum flow 28 so that, for example, a higher degree of suction may be applied to undesired material 12 in the elevated open storage tank 16, thereby increasing the transfer rate of undesired material 12 from the elevated open storage tank 16 and allowing more difficult material to be transferred out of the elevated open storage tank 16 (FIG. 1A).

As schematically depicted in FIG. 2H, which shows an example vacuum source 122 according to embodiments of the disclosure, the venturi mechanism 190 may include fluid supply ports 188 through which the supply of pressurized fluid from the fluid source 124 used to generate the vacuum is received. The venturi mechanism 190 also may include a vacuum port 206 through which the generated vacuum flow may be applied, and an exhaust port 208 through which the fluid flow used to generate the vacuum flow and any material drawn into the vacuum port 206 with the generated vacuum flow may be exhausted from the venturi mechanism 190.

Depending on the application, the vacuum source 122 may combine a number of venturi mechanisms 190 together. For example, the configurations shown in FIG. 2A, FIG. 2B, FIG. 2C, and FIG. 2D may contain a pair of venturi mechanisms 190. Alternatively, the configuration shown in FIG. 2F and FIG. 2G, for example, may contain forty or more venturi mechanisms 190 (e.g., four venturi mechanisms). The venturi mechanisms 190 may be operated simultaneously in parallel to provide a high-strength vacuum flow 28 and different levels of vacuum pressure.

In some embodiments, to generate the vacuum flow 28, the fluid supply ports 188 are pneumatically connected a fluid source 124 of the compressor and vacuum source assembly 114. For example, the fluid supply ports 188 may be pneumatically connected to a compressed fluid stored at or in the fluid source 124. The compressed fluid may be, for example, supplied by the one or more compressors 146 used to generate the fluid supply flow 200 from the fluid source 124. The fluid supply flow 200 may be received through the pneumatic connection and into the fluid supply ports 188. The fluid supply flow 200 may be configured to drive the venturi mechanism 190, thereby generating the vacuum flow 28 produced by the vacuum source 122, which may be applied to other devices via the vacuum port 206.

The strength of the vacuum flow 28 generated by the venturi mechanism 190 may depend at least in part on, for example, the rate of the fluid supply flow 200 used to drive the venturi mechanism 190 and the relative position of the venturi mechanism 190 in the compressor housing 120 relative to the one or more compressors 146. In order to achieve higher vacuum strength, in some embodiments, the vacuum source 122 may include a combiner 210. The combiner 210 may include a manifold for combining multiple fluid supply flows 200 received by the fluid supply ports 188 into a single fluid flow and directing the single fluid flow into the venturi mechanism 190 for generating the vacuum flow 28.

In some embodiments, to manage or control the flow rate, pressure, and/or volume of the fluid supply flow 200 into the venturi mechanism 190, which may be used to control or regulate the strength of the vacuum flow 28, fluid flow control valves 212 may be positioned between the fluid supply ports 188 and the fluid source 124. In some embodiments, the strength of the vacuum flow 28 generated by the venturi mechanism 190 may be substantially proportional to the flow rate, pressure, and/or volume of fluid flow into the fluid supply ports 188. The fluid flow control valves 212 may be used to limit (e.g., reduce, stop) the rate of fluid flow into the venturi mechanism 190 from the fluid supply ports 188.

In some embodiments, the vacuum port 206 may be pneumatically connected to the one or more vacuum boxes 62 and/or the vacuum manifold 70 to apply a vacuum to the one or more vacuum boxes 62 and/or vacuum manifold 70. Applying the vacuum may generate the vacuum-induced fluid flow 28 into the vacuum port 206. When connected to one or more vacuum boxes 62, the vacuum-induced fluid flow 28 may draw undesired material 12 into the one or more vacuum boxes 62 from the source of the material (e.g., the elevated open storage tank 16). A major portion of the undesired material 12 may be trapped by and within the one or more vacuum boxes 62, and a minor portion of the undesired material 12 may flow into the vacuum source 122 in vacuum-induced fluid flow 28.

To prevent or limit contamination of the ambient environment by a portion of any undesired material 12 which may be extracted, in some embodiments, the exhaust port 208 may be pneumatically connected to the sound attenuation chamber 126. For example, the exhaust port 208 may be pneumatically connected to the sound attenuation chamber 126, which may exhaust the vacuum-induced fluid flow 28, which may include the minor portion of the undesired material 12, and the fluid supply flow 200, for example, as a combined fluid flow into the sound attenuation chamber 126.

In some embodiments, the pneumatic connections between the ports 188, 206, and/or 208 of the vacuum source 122 may be made using conduits, such as hoses or other flexible tubular structures. The conduits may enable the pneumatic connections to be efficiently made, thereby reducing the setup time for assembling the material extraction assembly 10, for example, shown in FIGS. 1A-D. In some embodiments, the conduits may include relatively rigid piping (e.g., poly pipe or polyethylene pipe). The piping may render the conduits at least partially self-supporting, for example, when conveying high pressure or high vacuum pressure.

Applicant has recognized that the use of conduits, such as hoses or other flexible tubular structures may present a challenge. For example, the vacuum flow 28 generated by the vacuum source 122 may cause the conduits to flex or move due to the forces applied to them by the fluid flows. Equipment or other resources may be impacted by the conduits if the flexing or movement of the conduits is significant and/or unexpected. In some embodiments, the material extraction assembly 10 may reduce or eliminate one of more of the conduits, for example, by pneumatically connecting one or more of the components of the material extraction assembly 10 to one another in a manner that eliminates a need for at least some of the conduits (e.g., connecting components directly to one another). For example, the material extraction assembly 10, in some embodiments, may include direct attachment of the vacuum source 122 to one or more vacuum boxes 62, the vacuum manifold 70, and/or to the sound attenuation chamber 126. By directly attaching the vacuum source 122 to the one or more vacuum boxes 62, vacuum manifold 70, and/or the sound attenuation chamber 126, conduits, additional hoses or other flexible structures may not be necessary. As a result, the potential hazard of impact by uncontrolled movement by the conduits or other flexible structures may be reduced or eliminated.

As shown in FIG. 2B, FIG. 2D, and FIG. 2F, in some embodiments, fluidic communication may be provided between the vacuum source 122 in the compressor housing 120 and the sound attenuation chamber 126 to form a unified vacuum and attenuation module 140 on the common chassis 142. Connecting the vacuum source 122 to the sound attenuation chamber 126 may result in the vacuum-induced fluid flow flowing from the vacuum source 122 (e.g., as part of the vacuum exhaust fluid flow 202) directly into the sound attenuation chamber 126. In some such embodiments, both the vacuum source 122 and the sound attenuation chamber 126 may be rigid structures able to absorb forces applied to them by the vacuum flow 28 without significantly deforming or moving. The unified vacuum and attenuation module 140 may be fitted with lifting receiver members 214 (see FIG. 2E) so the vacuum source 122 and sound attenuation chamber 126 may be easily transported to and deployed by operators of the site using a forklift, crane, or other appropriate equipment and/or methods.

Applicant has recognized that the undesired material 12 may, in some instances, be challenging to move via fluid flow by virtue of, for example, the state of matter of the undesired material 12, the weight of the undesired material 12, the viscosity and/or surface tension of the undesired material 12, and/or other physical properties of the undesired material 12. Such characteristics of the undesired material 12 may limit the rate at which the undesired material 12 may flow through the fluid flow path if only a limited level of the vacuum flow 28 is generated by the vacuum generators 186. In some embodiments, the material extraction assembly 10 may be configured to provide a high-strength vacuum flow 28, which may be suitable to expedite flow of the undesired material 12 through the fluid flow path. As mentioned, to expedite the flow of the undesired material 12, the vacuum source 122, in some embodiments, may include two or more vacuum generators 186, such as two or more venturi mechanisms 190, which may be operated in parallel with each other in order to enhance the pressure of the vacuum flow 28 generated by the vacuum source 122. Each of the two or more vacuum generators 186 may be driven using the pressurized fluid from one or more fluid sources 124 (and/or other sources of pressurized fluid, such as mobile fluid supplies).

In some embodiments, to manage the pressure generated by vacuum source 122, the venturi mechanisms 190 may be divided into two dual vacuum sources. Each of the venturi mechanisms 190 of the two dual vacuum sources may be fluidly connected in parallel to each other, for example, so that they each may be driven using a common fluid supply port 188, may commonly exhaust out of a common exhaust port 208, and/or may apply vacuum using a common vacuum port 206. In this example manner, each dual vacuum source may provide a higher pressure vacuum flow 28 than may be provided using a single venturi mechanism 190 driven by a similar rate of fluid flow received from the fluid source 124 (e.g., the one or more compressors 146). To control the generation of the vacuum flow 28 by the one or more vacuum sources 122, in some embodiments, the ports 188, 206, and/or 208 of each dual vacuum source may be controlled by corresponding respective control valves 212, 216. The control valves 212, 216, may be usable to control the rate of fluid flow through each of the respective ports.

In some embodiments, to manage the process of generating the high-strength vacuum flow, the vacuum controller 162 may be in communication with one or more of the control valves 212, 216. The vacuum controller 162 may be configured to control operation of one or more of the control valves 212, 216 to provide vacuum flows having desired pressures. For example, the vacuum controller 162 may be operably coupled to an adjustor, such as a switch, dial, or other mechanism operable to achieve a desired level of vacuum pressure to be generated by the vacuum source 122. The vacuum controller 162 may use one or more signals from the adjustor to set the operation points for the one or more control valves 212, 216 to generate the desired vacuum pressure with, for example, the venturi mechanisms 190.

The vacuum controller 162 may include computing hardware (e.g., processors, memory, storage devices, communication devices, or other types of hardware devices including circuitry, among others) and/or computing instructions (e.g., computer code) that when executed by the computing hardware cause the vacuum controller 162 to provide its functionality. For example, the vacuum controller 162 may modify the quantities of power used to drive control valves 212, 216 to set the quantity of fluid flow through each of the ports 188, 206, and/or 208.

In some embodiments, to limit or prevent contamination of the ambient environment with any undesired material 12 from an extraction process, the sound attenuation chamber 126 may be configured remove undesired material 12 from the vacuum-induced fluid flow 28 prior to exhaustion into the ambient environment. To do so, the sound attenuation chamber 126 may be pneumatically connected to the vacuum source 122, for example, through exhaust flow paths 170 (e.g., conduit 170).

Applicant has recognized that some industrial environments, such as the elevated open storage tank 16 shown in FIG. 1A, may include personnel tasked to operate the equipment in these environments. The presence of such personnel may restrict the acceptable level of sound that may be produced for undesired material removal purposes. The sound attenuation chamber 126, according to some embodiments, may be configured to attenuate sound generated by the vacuum source 122 and/or the fluid source 124 to sufficient levels, such that personnel may not need to wear hearing protection due to the sound generated by the material extraction assembly 10. In some embodiments, the sound attenuation chamber 126 may be configured to reduce the sound level generated by the material extraction assembly 10 by an amount ranging from ten percent to forty percent (e.g., by twenty-five decibels). For example, without the sound attenuation chamber 126, according to some embodiments, the assembly 10 may generate approximately 115 decibels of sound. In contrast, when the sound attenuation chamber 126 is incorporated into the assembly 10, the sound level may be reduced to about 89 decibels.

The sound attenuation chamber 126, in some embodiments, may both filter materials received from fluid flows before exhausting the received fluid flows and attenuate sound from received fluid flows before exhausting the received fluid flows into the ambient environment. In some embodiments, the sound may be attenuated to an extent that personnel in the area need not wear hearing protection, although personnel may need to wear hearing protection for other reasons.

FIGS. 2E, 2G, and 2I illustrate examples of embodiments of a sound attenuation chamber 126. The sound attenuation chamber 126, in some embodiments, may include an attenuation housing 172 at least partially defining a chamber interior volume 174 positioned to receive at least a portion of the vacuum flow 28 from the vacuum source 122 and attenuate sound generated by the vacuum source 122 during operation. The attenuation housing 172 may substantially seal the interior volume 174 from the ambient environment. The attenuation housing 172 may include one or more walls or other structural members to seal or at least partially seal the interior volume 174.

In some embodiments, to filter undesired material 12 entering the sound attenuation chamber 126, the sound attenuation chamber 126 may include one or more inlet ports 176, one or more discharge ports 178, and/or one or more exhaust ports 180. At least some of the ports may be positioned on the attenuation housing 172 to provide access to the interior volume 174 from outside the attenuation housing 172. For example, the respective ports may include holes, apertures and/or other structures through one or more walls of the attenuation housing 172 that enable access to interior volume 174.

The inlet ports 176 may be pneumatically connected to the vacuum source 122. When pneumatically connected to the vacuum source 122, the inlet ports 176 may receive vacuum-induced flow 28 from the vacuum source 122. The minor portion of the undesired material 12 may be entrained in vacuum-induced flow 28, thereby presenting a potential contamination hazard if exhausted into the ambient environment without further filtering and/or treatment.

The exhaust ports 180, in some embodiments, may be pneumatically connected to the ambient environment. The fluid flow path through the material extraction assembly 10 may end at the exhaust ports 180. Consequently, in some embodiments, vacuum-induced flow 28 drawn from the elevated open storage tank 16 (e.g., from the suction head 52 of the submersible robot 34) and through the flow path may exit the flow path through the exhaust ports 180. The interior volume 174 may be in the flow path between the inlet ports 176 and the exhaust ports 180, such that vacuum-induced flow 28 flows through the interior volume 174 prior to being exhausted into the ambient environment.

In some embodiments, to partially attenuate sound, the exhaust ports 180 may be of substantially larger size than the inlet ports 176. The size difference between these ports may reduce or eliminate backpressure on the vacuum-induced flow 28. The flow path may expand greatly in cross-sectional area as the vacuum-induced flow 28 transitions from the inlet ports 176 into the interior volume 174. As a result, any sound generated by the vacuum-induced flow 28 may generally occur at an interface between the inlet ports 176 and the interior volume 174. In some embodiments, accordingly, the sound attenuation chamber 126 may, in part, dissipate the sound generated by the vacuum-induced flow 28 by generating it within the sound attenuation chamber 126, for example, such that the sound will dissipate prior to exiting the sound attenuation chamber 126.

In some embodiments, to filter undesired material 12 prior to exhaustion to the ambient environment, the interior volume 174 may include a filter media region 182, as seen in FIGS. 2I and 2J. The filter media region 182 may include a portion of the interior volume 174 in which filter media 184 may be positioned. The filter media region 182 may be positioned, for example, such that the vacuum-induced flow 28 must substantially flow through the filter media region 182 and filter media 184 prior to being exhausted through the exhaust ports 180 to the ambient environment. In some embodiments, the interior volume 174 may include a filter media support plate 218. The filter media support plate 218 may be configured to support the filter media 184 within the filter media region 182. In some embodiments, the filter media support plate 218 may generally divide the interior volume 174 into two or more sections and may include holes through which the vacuum-induced flow 28 may travel between the sections. One or both sides of the filter media support plate 218 may include one or more baffles 220 configured to attenuate sound. The one or more baffles 220 may attenuate sound generated by the vacuum-induced flow 28, for example, prior to exhaustion out of the sound attenuation chamber 126.

In some embodiments, to filter undesired material 12 prior to being exhausted to the ambient environment, the filter media 184 may be configured to filter at least a portion of the minor portion of the undesired material 12 from the vacuum-induced flow 28. The filter media 184 may include any type of filter media for removing material from fluid flows. The filter media 184 also may be sound absorptive and, in part, help to dissipate the sound generated by the vacuum-induced flow 28. The filter media 184 may, in some examples, exhibit a relatively limited filtration capacity. As filter media 184 filters the undesired material 12, its permeability to fluid flow may decrease.

To manage the filtration capacity of the filter media 184, in some embodiments, the sound attenuation chamber 126 may include one or more jet generators 222 (see FIG. 2E and FIG. 2G) positioned relative to the sound attenuation chamber 126 to generate jets of fluid flow directed toward the filter media 184 to at least partially maintain the filtration capacity of the filter media 184. For example, the jet generators 222 may be positioned to generate jets of fluid flow directed toward the filter media 184 to at least partially refresh or restore the filtration capacity of filter media 184. For example, the jet generators 222 may be positioned outside the attenuation housing 172 and oriented facing into the filter media region 182.

When the jet generators 222 generate the jets, the jets may transfer undesired material 12 filtered by the filter media 184 out of the filter media 184 and into the interior volume 174. This may, in some embodiments, at least partially restore the permeability and/or the filtration capacity of the filter media 184. For example, the jets may cause undesired material 12 trapped in the filter media 184 to drop out of the filter media region 182, for example, through holes in the filter media support plate 218 and into interior volume 174.

To drive the jet generators 222, in some embodiments, the sound attenuation chamber 126 may include a jet fluid supply 224. The jet fluid supply 224 may be configured to store compressed fluid. In some embodiments, the jet fluid supply 224 may include a storage tank in which the compressed fluid is stored. The compressed fluid may be a gas, such as, for example, compressed air. The jet fluid supply 224 may be pneumatically coupled to the jet generators 222. The jet generators 222 may include one or more ports and one or more electrically driven actuators configured to control the rate at which the compressed fluid from the jet fluid supply 224 exits the jet generators 222. Thus, the jet generators 222 may modulate one or more of a strength of the jets of fluid flow, timing of the jets of fluid flow, or one or more other characteristics associated with the jets of fluid flow.

To fill the jet fluid supply 224, in some embodiments, the sound attenuation chamber 126 may include a fluid supply port 226. The fluid supply port 226 may be pneumatically connected to the jet fluid supply 224 to refill the jet fluid supply 224 with compressed fluid, for example, when another source of compressed fluid (e.g., the fluid source 124) is pneumatically coupled to the fluid supply port 226.

In some embodiments, due to a limited size of the interior volume 174, only a finite quantity of undesired material 12 may be stored in the interior volume 174. Over time the interior volume 174 may become filled with undesired material 12 as undesired material 12 is removed from the elevated open storage tank 16. Once the interior volume 174 is filled, the sound attenuation chamber 126 may become inoperable, for example, as undesired material 12 may block fluid flow through the interior volume 174.

To manage the fill level of the interior volume 174, in some embodiments, the sound attenuation chamber 126 may include one or more discharge ports 178. The discharge ports 178 may facilitate removal of undesired material 12 from the interior volume 174. In some embodiments, undesired material 12 may be removed from the interior volume 174 through the discharge port(s) 178 while the vacuum-induced flow 28 flows through the interior volume 174.

To remove undesired material 12 from the interior volume 174, in some embodiments, the discharge port 178 may be pneumatically connected to one or more vacuum boxes 62. For example, the discharge port 178 may be pneumatically connected to one or more vacuum boxes 62 via a conduit 228 (e.g., such as a restrictive hose). When a high-strength vacuum is applied to the one or more vacuum boxes 62, undesired material 12 in the interior volume 174 may be drawn out of the interior volume 174, through the conduit 228, and into the vacuum boxes 62. Thus, both the major portion and the minor portion of the undesired material 12 extracted from the elevated open storage tank 16 may be transferred to one or more vacuum boxes 62. The discharge port 178 may be pneumatically connected to other components for undesired material discharge purposes without departing from embodiments disclosed herein.

To control when and/or the rate of removal of the undesired material 12 from the interior volume 174, in some embodiments, the sound attenuation chamber 126 may include a discharge port control valve 230. The discharge port control valve 230 may be positioned to control the rate of fluid flow through the discharge port 178. For example, the discharge port control valve 230 may include an electrically driven actuator usable to control the rate of fluid flow through discharge port 178. In some embodiments, the discharge port control valve 230 may control the rate of fluid flow through discharge port 178 to selectively remove undesired material 12 from the interior volume 174.

To determine when and/or at which rate to remove undesired material 12 from the interior volume 174, in some embodiments, the sound attenuation chamber 126 may include one or more sensors 232. The sensors 232 may be positioned to monitor the filtration capacity of the filter media 184, the fill level of the interior volume 174, and/or the flow rate of undesired material 12 out of the discharge port 178. The sensors 232 may be configured to generate signals indicative of any physical property of the sound attenuation chamber 126 and use the signals to determine these quantities. For example, the sensors 232 may include photo-sensors that measure the filtration capacity of the filter media 184 based on a quantity of light transmitted by the filter media 184. In some embodiments, the sensors 232 may include a transducer configured to measure the mass of undesired material 12 to determine the fill level of the interior volume 174. The sensors 232 may include other components for measuring the same or different types of physical properties without departing from embodiments disclosed herein.

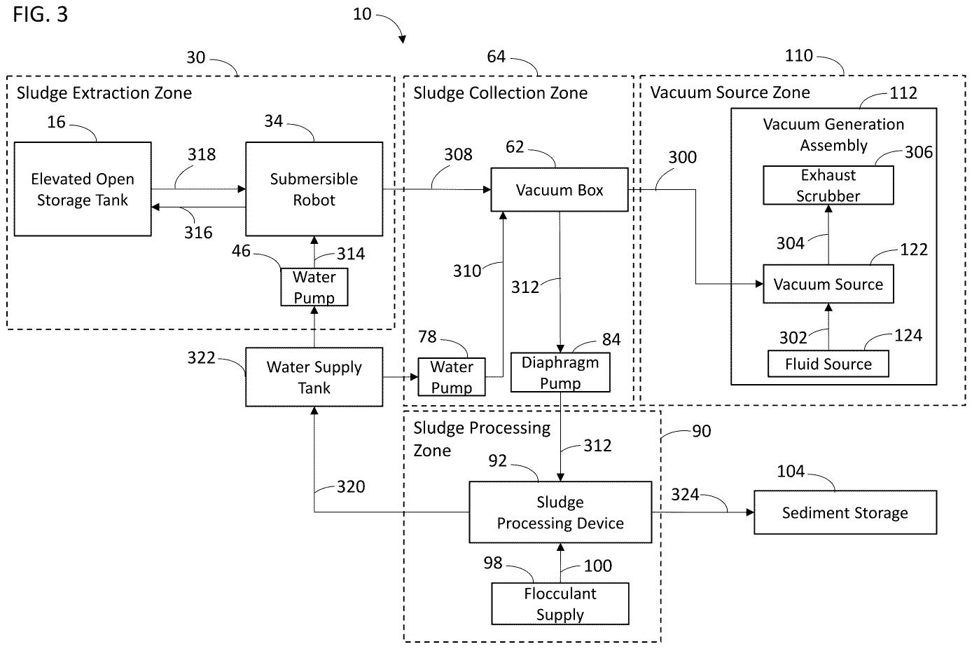

FIG. 3 is a process flow diagram illustrating an embodiment of the material extraction assembly 10. For the illustrated embodiment, the material extraction assembly 10 includes a sludge extraction zone 30, a sludge collection zone 64, a sludge processing zone 90, and a vacuum source zone 110. The vacuum source zone 110 includes at least one vacuum generation assembly 112 configured to generate a vacuum flow 300. For the illustrated embodiment, the vacuum generation assembly 112 includes a vacuum source 122 that is fluidly connected to a fluid source 124 to receive a flow of a pressurized fluid 302 (e.g., compressed air) from a fluid source 124 (e.g., an air compressor). As discussed herein, the vacuum source 122 includes a plurality of venturis arranged to receive and transform the flow of the pressurized fluid 302 into a vacuum flow 300 while also generating an exhaust stream 304. The exhaust stream 304 includes the flow of the pressurized fluid 302 in addition to various gases and vapors that are introduced into the vacuum flow during sludge extraction and collection. As such, in some cases, the exhaust stream 304 may include one or more gases or vapors, such as hydrogen sulfide (H₂S). In some embodiments, the vacuum generation assembly 112 includes an exhaust scrubber 306 configured to remove one or more gases or vapors from the exhaust stream 304 before it is released into the atmosphere. For example, in some embodiments, the exhaust scrubber 306 includes an H₂S scrubber that removes H₂S from the exhaust stream 304. As discussed herein, for embodiments that include multiple vacuum generation assemblies, one or more manifolds may be fluidly connected between the one or more vacuum boxes and the multiple vacuum generation assemblies to facilitate sludge extraction and collection.

For the embodiment illustrated in FIG. 3, the sludge collection zone 64 includes at least one vacuum box 62 that is fluidly connected to the vacuum source 122 of the at least one vacuum generation assembly 112 to receive the vacuum flow 300. The vacuum box 62 is fluidly connected to supply the vacuum flow 300 to the submersible robot 34 of the sludge extraction zone 30 to motivate the extracted fluidized sludge 308 to be collected within the one or more vacuum boxes 62. In some embodiments, each of the vacuum boxes 62 may include one or more water jets fluidly connected to a water pump 78 that supplies a pressurized flow of water 310 to fluidize or re-fluidize the collected sludge. The sludge collection zone 64 further includes the diaphragm pump 84 that is fluidly connected to the one or more vacuum boxes 62 to pump fluidized sludge 312 from the vacuum boxes and into the sludge processing device 92 of the sludge processing zone 90. As discussed herein, for embodiments that include multiple vacuum boxes 62, one or more manifold may be fluidly connected (i) between the submersible robot 34 and the multiple vacuum boxes to facilitate sludge extraction and collection, (ii) between the at least one vacuum generation assembly 112 and the multiple vacuum boxes 62 to facilitate sludge extraction and collection, and/or (iii) between the diaphragm pump 84 and the multiple vacuum boxes 62 to facilitate sludge processing.

For the embodiment illustrated in FIG. 3, the sludge extraction zone 30 includes the submersible robot 34 and the elevated open storage tank 16 that contains the sludge to be extracted. As discussed herein, the submersible robot 34 includes at least one water jet that is fluidly connected to receive a pressurized flow of water 314 from a water pump 46, in which the at least one water jet delivers at least one jet of pressurized water 316 into the sludge to fluidize the sludge for extraction and collection. The submersible robot 34 includes at least one suction head that is fluidly connected to the one or more vacuum boxes 62 to receive the vacuum flow generated by the vacuum generation assembly 112. The submersible robot 34 utilizes the vacuum flow to extract the fluidized sludge 318 from the elevated open storage tank 16 and to supply a flow of fluidized sludge 308 to the one or more vacuum boxes 62 for collection.

For the embodiment illustrated in FIG. 3, the sludge processing zone 90 includes the sludge processing device 92 that is fluidly connected to the diaphragm pump 84 of the sludge collection zone 64 to receive the flow of fluidized sludge 312 from the one or more vacuum boxes 62 for processing. In some embodiments, at least one flocculant 100 may be introduced by the flocculant supply 98 into the flow of fluidized sludge 312 prior to or upon entering the sludge processing device 92. The sludge processing device 92 separates the aqueous liquid from the flow of fluidized sludge 312 and directs a flow of recovered water 320 to a water supply tank 102. In some embodiments, the water supply tank 322 may serve as the source of water for the water pump 46 of the sludge extraction zone 30 and/or the water pump 78 of the sludge collection zone 64. The sludge processing device 92 further separates sediment from the flow of fluidized sludge 312 and directs a stream of recovered sediment 324 to sediment storage 104. In some embodiments, the stream of recovered sediment 324 may be transferred to sediment storage 104 using a conveyor belt or another suitable solid conveyance mechanism. In some embodiments, sediment storage 104 may include a second open top storage tank receives and stores the sediment.

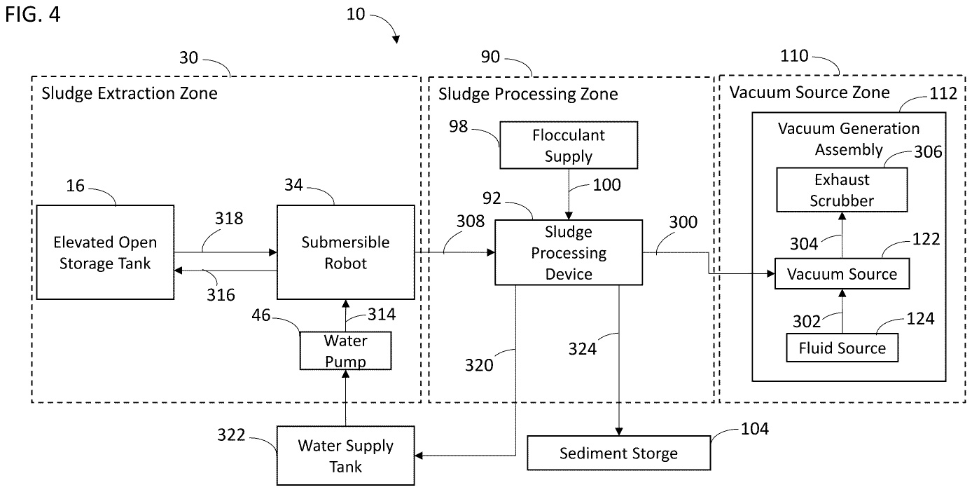

FIG. 4 is a process flow diagram illustrating another embodiment of the material extraction assembly 10. For the illustrated embodiment, the material extraction assembly 10 includes a sludge extraction zone 30, a sludge processing zone 90, and a vacuum source zone 110. The sludge extraction zone 30 and the vacuum source zone 110 may be configured as described above with respect to FIG. 3. Unlike the embodiment of the material extraction assembly 10 illustrated in FIG. 3, the embodiment of the material extraction assembly 10 illustrated in FIG. 4 lacks the sludge collection zone 64. Instead, for the embodiment illustrated in FIG. 4, the sludge processing device 92 is fluidly connected to the vacuum source of at least one vacuum generation assembly 112 of the vacuum source zone 110 to receive the vacuum flow 300. The sludge processing device 92 is also fluidly connected to receive the flow of the fluidized sludge 308 extracted by submersible robot 34 of the sludge extraction zone 30. The sludge processing device 92 processes the received flow of fluidized sludge 312 as described above. The embodiment of the material extraction assembly 10 illustrated in FIG. 4 offers certain advantages over the embodiment of the material extraction assembly 10 illustrated in FIG. 3, such as a reduced amount of equipment (e.g., vacuum boxes, manifolds, vacuum hoses, pipes). Additionally, the material extraction assembly 10 illustrated in FIG. 4 may not require a vacuum flow having as high of a vacuum strength or vacuum flow rate as is used for the embodiment of the material extraction assembly 10 illustrated in FIG. 3 due to the reduced volume of the material extraction assembly 10 that contains the vacuum flow during operation. In contrast, the embodiment of the material extraction assembly 10 illustrated in FIG. 3 offers advantages over the material extraction assembly 10 illustrated in FIG. 4, such as the ability to continue sludge extraction and collection even when the sludge processing device 92 is offline and/or the ability to continue sludge processing even when the submersible robot 34 or the vacuum source zone 110 is offline.

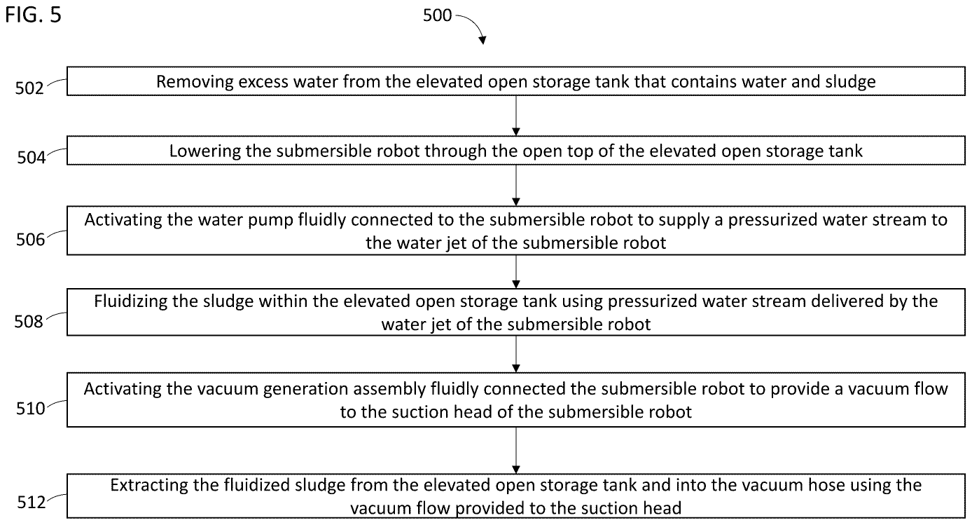

FIG. 5 is a flow diagram of an embodiment of a method 500 of sludge extraction. The method 500 is discussed with reference to elements illustrated in FIGS. 1A-1D, 3, and 4. In some embodiments, at least a portion of the method 500 may be performed in response to control signals from a control system of the material extraction assembly 10. For the illustrated embodiment, the method 500 begins with removing excess water from the elevated open storage tank 16 that contains water and sludge (block 502). For example, when the elevated open storage tank 16 includes a substantial volume of water above the sludge, at least a portion of the excess water may be removed from the tank to allow access to the sludge layer. In some embodiments, the excess water may be drained from an existing inlet or outlet of the elevated open storage tank, while in some embodiments, the excess water may be pumped from the open top of the tank. In some embodiments, the excess water may be transferred to a water tank (e.g., water supply tanks 50, 80, or 102) and subsequently used to supply water to water jets to facilitate sludge extraction and collection, as discussed herein.

For the illustrated embodiment, the method 500 continues with lowering the submersible robot through the open top of the elevated open storage tank 16 (block 504). For example, the cable 42 from the crane 32 may be attached to the submersible robot 34 and the submersible robot 34 lowered into the elevated open storage tank 16 to the height 24 of the layer of sludge 18 or slightly above the height 24 of the sludge layer. Additionally, in some embodiments, parameters of the crane 32 (e.g., position of the main boom 36, telescoping extensions 38, winch 40) may be adjusted to suitably position the submersible robot 34 within the interior of the elevated open storage tank 16 for sludge extraction.

For the illustrated embodiment, the method 500 continues with activating the water pump 46 of the sludge extraction zone 30 that is fluidly connected to the submersible robot 34 to supply a pressurized water stream to at least one water jet 44 of the submersible robot 34 (block 506). The method 500 includes fluidizing the sludge within the elevated open storage tank 16 using pressurized water stream delivered by at least one water jet 44 of the submersible robot 34 (block 508). In some embodiments, the water jet 44 of the submersible robot 34 may be actuated to point in a particular direction and/or at a particular angle to facilitate fluidization of the sludge.

For the illustrated embodiment, the method 500 continues with activating the at least one vacuum generation assembly 112 fluidly connected the submersible robot to provide a vacuum flow to at least one suction head 52 of the submersible robot 34 (block 510). The method 500 includes extracting the fluidized sludge from the elevated open storage tank 16 and into the vacuum hose 26 using the vacuum flow provided to at least one suction head 52 of the submersible robot 34 (block 512). In some embodiments, various parameters of equipment in the sludge extraction zone 30 (e.g., the position of the submersible robot 34 within the elevated open storage tank 16, direction and/or angle of the water jet 44, pressure of jetted water 54, direction and/or angle of the suction head 52) throughout the sludge extraction operation. For example, as the height 24 of the sludge layer decreases as a result of sludge extraction, the submersible robot 34 may be lowered further into the elevated open storage tank 16 to continue sludge extraction.

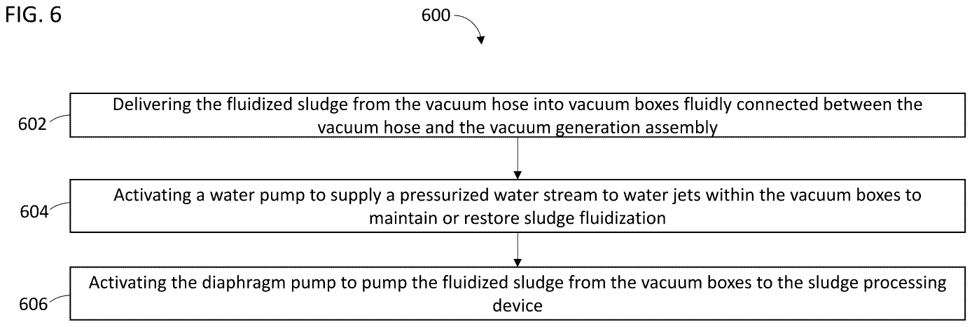

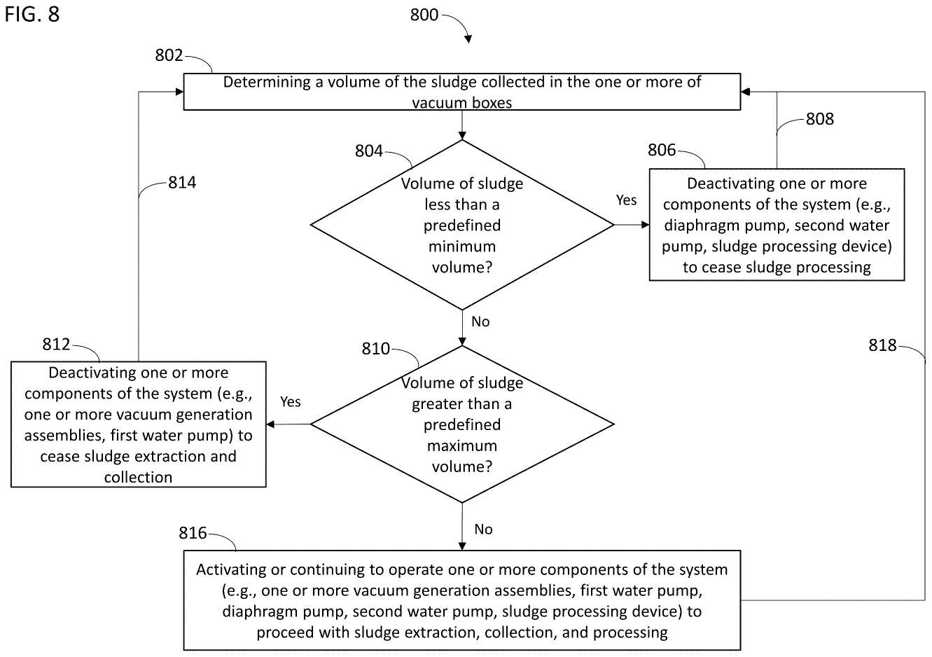

FIG. 6 is a flow diagram of an embodiment of a method 600 of sludge collection. The method 600 is discussed with reference to elements illustrated in FIGS. 1A-1D and 4. In some embodiments, at least a portion of the method 600 may be performed in response to control signals from a control system of the material extraction assembly 10. For the illustrated embodiment, the method 600 begins with delivering the fluidized sludge extracted by at least one suction head 52 of the submersible robot 34 from the vacuum hose 26 into one or more vacuum boxes 62 fluidly connected between the vacuum hose 26 and at least one vacuum generation assembly (block 602). The method 600 continues with activating the water pump 78 of the sludge collection zone 64 to supply a pressurized water stream to water jets 76 within the vacuum boxes 62 to maintain or restore sludge fluidization (block 604). The method 600 includes activating the diaphragm pump 84 to pump the fluidized sludge from the vacuum boxes 62 to the sludge processing device 92 (block 606). In some embodiments, as the fluidized sludge is delivered into the vacuum boxes 62, various aspects of the sludge collection process may be monitored (e.g., the flow rate of fluidized sludge, density of the fluidized sludge, fluidization of the fluidized sludge, volume of fluidized sludge collected in each vacuum box, remaining capacity of each vacuum box) and various operational parameters of the sludge collection zone 64 may be adjusted in response, for example, as discussed with respect to FIG. 8.

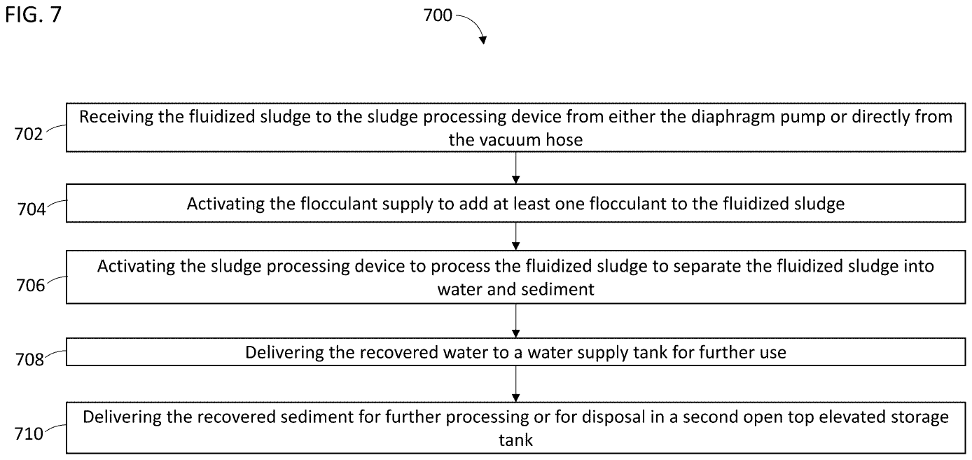

FIG. 7 is a flow diagram of an embodiment of a method 700 of sludge processing. The method 700 is discussed with reference to elements illustrated in FIGS. 1A-1D, 3, and 4. In some embodiments, at least a portion of the method 700 may be performed in response to control signals from a control system of the material extraction assembly 10. For the illustrated embodiment, the method 700 begins with receiving the fluidized sludge to the sludge processing device 92 from either the diaphragm pump 84 or directly from the vacuum hose 26 (block 702). For example, for embodiments that include the sludge collection zone 64 with one or more vacuum boxes 62, the fluidized sludge may be received from the diaphragm pump 84 that is fluidly connected between the vacuum boxes 62 and the sludge processing device 92. For embodiment that lack the sludge collection zone 64, such as the embodiment of the material extraction assembly 10 illustrated in FIG. 4, the fluidized sludge may be received directly from the vacuum hose 26 that is that is fluidly connected to the submersible robot 34.

For the illustrated embodiment, the method 700 may include providing control signals to activate the flocculant supply 98 to add at least one flocculant 100 to the fluidized sludge (block 704). For example, in some embodiments, flocculant 100 may be added to the fluidized sludge before it reaches the sludge processing device 92, while in other embodiments, flocculant 100 may be added to the fluidized sludge as it is introduced to the sludge processing device 92. The method 700 continues with activating the sludge processing device 92 to process the fluidized sludge to separate the fluidized sludge into water and sediment (block 706). The method 700 includes delivering the recovered water to a water supply tank for further use (block 708). The method 700 includes delivering the recovered sediment for further processing or for disposal in a second open top elevated storage tank (block 710).

FIG. 8 is a flow diagram of an embodiment of a method 800 of managing sludge collection and processing. The method 800 is discussed with reference to elements illustrated in FIGS. 1A-1D and 3. In some embodiments, at least a portion of the method 800 may be performed in response to control signals from a control system of the material extraction assembly 10. In some embodiments, the method 800 may be performed after initiating sludge extraction (e.g., according to the method 500 of FIG. 5), sludge collection (e.g., according to the method 600 of FIG. 6) and initiating sludge processing (e.g., according to the method 700 of FIG. 7).

For the embodiment illustrated in FIG. 8, the method 800 begins with determining a volume of the sludge in the one or more of vacuum boxes 62 of the sludge collection zone 64 (block 802). For example, in some embodiments, the one or more vacuum boxes 62 may be equipped with one or more sensors 82, such as fill sensors that measure the height or weight of sludge collected in the vacuum boxes 62 or flow sensors that measure the volume of sludge that has been introduced into the vacuum boxes 62. In some embodiments, a control system of the material extraction assembly 10 receives measurements from the one or more sensors 82 of the vacuum boxes 62 to calculate the volume of sludge collected in the vacuum boxes 62 of the sludge collection zone 64.

For the embodiment illustrated in FIG. 8, the method 800 includes determining (decision block 804) whether the volume of collected sludge in the vacuum boxes 62 is less than a predefined minimum volume. For example, a control system of the material extraction assembly 10 may be configured with a predefined minimum volume that defines the minimum volume of sludge that should be present in the one or more vacuum boxes 62 of the sludge collection zone 64 when the diaphragm pump 84 and the sludge processing device 92 are active to facilitate sludge processing. Responsive to determining that the volume of collected sludge in the vacuum boxes 62 is less than the predefined minimum volume, the method 800 includes deactivating one or more components of the material extraction assembly 10 (e.g., the diaphragm pump 84 and the water pump 78 of the sludge collection zone 64, the sludge processing device 92 of the sludge processing zone 90) to at least temporarily cease sludge processing (block 806). After deactivating the one or more components of the material extraction assembly 10 to cease sludge processing, as indicated by the arrow 808, the method 800 may continue with again determining the volume of the sludge in the one or more of vacuum boxes 62 of the sludge collection zone 64 (block 802), for example, after a predetermined delay to allow the sludge collection zone 64 to collect additional sludge for processing.

For the embodiment illustrated in FIG. 8, responsive to determining (decision block 804) that the volume of collected sludge in the vacuum boxes 62 is greater than or equal to the predefined minimum volume, the method 800 continues with determining (decision block 810) whether the volume of collected sludge in the vacuum boxes 62 is greater than a predefined maximum volume. For example, a control system of the material extraction assembly 10 may be configured with a predefined maximum volume that defines the maximum volume of sludge that can be collected within the one or more vacuum boxes 62, for example, to prevent overflow of the vacuum boxes 62 of the sludge collection zone 64 due to excess sludge collection. Responsive to determining that the volume of collected sludge in the vacuum boxes 62 is greater than the predefined maximum volume, the method 800 includes deactivating one or more components of the material extraction assembly 10 (e.g., the one or more vacuum generation assemblies 112 of the vacuum source zone 110, the water pump 46 of the sludge extraction zone 30) to at least temporarily cease sludge extraction and collection (block 812). As indicated by the arrow 814, the method 800 may continue with again determining the volume of the sludge in the one or more of vacuum boxes 62 of the sludge collection zone 64 (block 802), for example, after a predetermined delay to allow the sludge processing zone 90 to process additional sludge from the sludge collection zone 64.

For the embodiment illustrated in FIG. 8, responsive to determining (decision block 804) that the volume of collected sludge in the vacuum boxes 62 is greater than or equal to the predefined minimum volume and determining (decision block 810) that the volume of collected sludge in the vacuum boxes 62 is less than or equal to the predefined maximum volume, the method 800 continues with activating or continuing to operate the components of the material extraction assembly 10 (e.g., the diaphragm pump 84 and the water pump 78 of the sludge collection zone 64, the sludge processing device 92 of the sludge processing zone 90, the one or more vacuum generation assemblies 112 of the vacuum source zone 110, the water pump 46 of the sludge extraction zone 30) to proceed with sludge extraction, collection, and processing (block 816). As indicated by the arrow 818, the method 800 may continue with again determining the volume of the sludge in the one or more of vacuum boxes 62 of the sludge collection zone 64 (block 802) to continue monitoring volume of sludge in the one or more of vacuum boxes 62 throughout sludge extraction, collection, and processing.

FIG. 9 is a diagrammatic representation of an embodiment of a control system 900 associated with the material extraction assembly 10. In some examples, the control system 900 includes a controller 902 or one or more controllers. While described herein as a controller, it may be appreciated that, in other embodiments, the controller may be or include any suitable computing system, such as a desktop, laptop, or tablet computing device. Additionally, while the control system 900 is illustrated and described as including a single controller 902, in some embodiments, the operation of the controller may instead be implemented using a collection of controllers in signal communication with one another.

The controller 902 of various examples disclosed herein includes one or more processors, such as processor 904, as well as a memory or machine-readable storage medium, such as memory 906. As used herein, a “machine-readable storage medium” may be any electronic, magnetic, optical, or other physical storage apparatus to contain or store information such as executable instructions, data, and the like. For example, any machine-readable storage medium described herein may be any of random-access memory (RAM), volatile memory, non-volatile memory, flash memory, a storage drive, a hard drive, a solid-state drive, any type of storage disc, and the like, or a combination thereof. The memory 906 stores or includes instructions executable by the processor 904. As used herein, a “processor” includes, for example, one processor or multiple processors included in a single device or distributed across multiple computing devices. The processor 904 may be at least one of a central processing unit (CPU), a semiconductor-based microprocessor, a graphics processing unit (GPU), a field-programmable gate array (FPGA) to retrieve and execute instructions, a real-time processor (RTP), other electronic circuitry suitable for the retrieval and execution instructions stored on a machine-readable storage medium, or a combination thereof.

The controller 902 includes an I/O interface 908 that enables the controller 902 to be in signal communication with other components associated with sludge extraction, collection, and processing. For example, these components may include components of the sludge extraction zone 30, the sludge collection zone 64, the vacuum source zone 110, and/or the sludge processing zone 90. As used herein, “signal communication” refers to electric communication such as hard wiring two components together or wireless communication, as understood by those skilled in the art. For example, wireless communication may be Wi-Fi®, Bluetooth®, ZigBee, or forms of near field communications. In addition, signal communication may include one or more intermediate controllers or relays disposed between elements that are in signal communication with one another. In the drawings and specification, several examples of systems and methods of sludge extraction, collection, and processing are disclosed.

The memory 906 of the controller 902 includes instructions executed by the processor 904 to facilitate sludge extraction, collection, and/or processing according to the examples disclosed herein. For the illustrated embodiment, these instructions may include instructions of a sludge extraction zone control module 910 that controls and monitors operation of components within the sludge extraction zone 30, a vacuum source zone control module 912 that controls and monitors operation of components within the vacuum source zone 110, a sludge collection zone control module 914 that controls and monitors operation of components within the sludge collection zone 64, and a sludge processing zone control module 916 that controls and monitors operation of components within the sludge processing zone 90. For example, in some embodiments, the sludge extraction zone control module 910 may include instructions to implement some or all of the method 500 of sludge extraction illustrated in FIG. 5. In some embodiments, the sludge collection zone control module 914 may include instructions to implement some or all of the method 600 of sludge processing illustrated in FIG. 6. In some embodiments, the sludge processing zone control module 916 may include instructions to implement some or all of the method 700 of sludge processing illustrated in FIG. 7. In some embodiments, the sludge collection zone control module 914 and/or the sludge processing zone control module 916 may include instructions to implement some or all of the method 800 of controlling sludge collection and processing illustrated in FIG. 8.

For example, in some embodiments, the sludge extraction zone control module 910 may include instructions to receive measurements from components of the sludge extraction zone 30 and/or provide control signals to control operation of components of the sludge extraction zone 30. As discussed herein, the components of the sludge extraction zone 30 include the submersible robot 34. In some embodiments, the submersible robot 34 includes at least one water jet 44, and the instructions of the sludge extraction zone control module 910 include instructions to adjust the direction, the angle, and/or the flow rate of pressurized water delivered by the water jet to fluidize the sludge. In some embodiments, the submersible robot 34 includes at least one suction head 52, and the instructions of the sludge extraction zone control module 910 may include instructions to adjust the direction, the angle, and/or the flow rate of fluidized sludge extracted by the suction head 52. In some embodiments, the submersible robot 34 may include one or more sensors 58. For example, the one or more sensors 58 may include one or more proximity sensors that provide measurements to the controller 902 indicating the position of the submersible robot 34 within the elevated open storage tank 16, one or more pressure sensors that provide measurements to the controller 902 indicating the pressure of the pressurized flow of water delivered to the water jet 44 and/or the pressure of the vacuum flow delivered to the suction head 52. The one or more sensors 58 may include one or more flow sensors that provide measurements to the controller 902 indicating the flow rate of pressurized water delivered by the water jet 44 and/or the flow rate of fluidized sludge collected by the suction head 52.

As discussed herein, the components of the sludge extraction zone 30 may include the crane 32. In some embodiments, the crane 32 may include a main boom 36, telescoping extensions 38, and a winch 40, and the instructions of the sludge extraction zone control module 910 may include instructions to provide control signals to the crane 32 to adjust the position of submersible robot 34 in the elevated open storage tank 16. In some embodiments, the sludge extraction zone 30 may include one or more flow control devices 918, such as a flow control device positioned to regulate the flow of pressurized water delivered to the water jet 44 of the submersible robot 34 and/or a flow control device positioned to regulate the vacuum flow delivered to the suction head 52 of the submersible robot 34. In some embodiments, the instructions of the sludge extraction zone control module 910 may include instructions to provide control signals to the flow control devices to increase or decrease the flow of pressurized water delivered to the water jet 44 of the submersible robot 34 and/or the vacuum flow delivered to the suction head 52 of the submersible robot 34.

As discussed herein, the components of the vacuum source zone 110 includes at least one vacuum generation assembly 112. As described herein, each vacuum generation assembly 112 includes at least one fluid source 124 and at least one vacuum source 122, and the instructions of the vacuum source zone control module 912 may include instructions to adjust the operational parameters of these components, for example, to activate and deactivate the vacuum generation assembly 112 to achieve a predefined vacuum pressure, a predefined vacuum flow, and/or a predefined sludge extraction/collection rate. Additionally, in some embodiments, the vacuum source zone may include one or more sensors 920, such as pressure sensors and/or flow sensors that provide measurements to the controller 902 regarding the pressure and/or flow rate of the vacuum flow generated by the vacuum generation assembly 112. In some embodiments, the vacuum source zone 110 may include one or more flow control devices 922, such as a flow control device positioned to regulate the pressure and/or vacuum flow provided by the vacuum generation assembly 112. In some embodiments, the instructions of the vacuum source zone control module 912 may include instructions to provide control signals to the one or more flow control devices 922 to increase or decrease pressure and/or the vacuum flow provided by the vacuum generation assembly 112.

As discussed herein, for embodiments that include the sludge collection zone 64, the components of the sludge collection zone 64 include one or more vacuum boxes 62. In some embodiments, the vacuum boxes 62 may include one or more water jets 76, and the instructions of the sludge collection zone control module 914 may provide control signals, for example, to selectively activate and deactivate the water jets 76, to change a direction or angle of the water jets 76, to adjust the flow of pressurized water through the water jets 76 to achieve a desired level of fluidization of the collected sludge. In some embodiments, each of the one or more vacuum boxes 62 may be equipped with sensors 82, such as one or more fill sensors that provide measurements to the controller indicating the volume of sludge collected, and/or one or more fluidization sensors that provide measurements to the controller regarding the fluidity of the collected sludge. In some embodiments, the sludge collection zone 64 may include one or more water pumps 78 that supply the pressurized flow of water to the water jets 76 of the vacuum boxes 62, and the instructions of the sludge collection zone control module 914 may include instructions, for example, to selectively activate and deactivate the water pumps 78 and/or adjust a pressure or flow rate of the pressurized flow of water to fluidize the collected sludge. The sludge collection zone 64 further includes one or more diaphragm pumps 84 to pump the collected sludge from the vacuum boxes to the sludge processing zone 90, and the instructions of the sludge collection zone control module 914 may include instructions, for example, to selectively activate and deactivate the diaphragm pumps 84 and/or adjust a pressure or flow rate of the sludge through the one or more diaphragm pumps 84. In some embodiments, the sludge collection zone 64 may include various sensors 924, such as pressure sensors and/or flow sensors that provide measurements to the controller 902 indicating the pressure and/or flow of the pressurized flow of water delivered to the water jets 76 and/or the pressure and/or flow of the sludge being delivered into and/or being pumped out of the vacuum boxes 62. In some embodiments, the sludge collection zone 64 may include one or more flow control devices 926, such as a flow control device positioned to regulate the pressure and/or vacuum flow provided to the one or more vacuum boxes 62 and/or a flow control device positioned to regulate the flow of sludge into and out of the vacuum boxes 62. In some embodiments, the instructions of the sludge collection zone control module 914 may include instructions to provide control signals to the one or more flow control devices 926 to increase or decrease pressure and/or the vacuum flow and/or to increase or decrease the flow of sludge into or out of the vacuum boxes 62.

As discussed herein, the sludge processing zone 90, includes one or more sludge processing devices 92. In some embodiments, the sludge processing devices 92 may include a centrifuge, and the instructions of the sludge processing zone control module 916 may provide control signals to adjust operational parameters of the centrifuge, such as to selectively activate and deactivate the centrifuge, to adjust a rotational rate of the centrifuge, and/or to modify other parameters of the centrifuge. In some embodiments, the sludge processing devices 92 may include a shaker, and the instructions of the sludge processing zone control module 916 may provide control signals to adjust operational parameters of the shaker, such to selectively activate and deactivate the shaker, to adjust a position of one or more screens, to adjust the G force that the shaker applies to the sludge during processing, and/or to modify other parameters of the shaker. In some embodiments, the sludge processing zone 90 may include various sensors 928, such as pressure sensors and/or flow sensors that provide measurements to the controller indicating the pressure and/or flow rate of the pressurized flow of the sludge being delivered to the sludge processing device 92 from the sludge collection zone 64, the pressure and/or flow rate of the recovered water 320 supplied to the water supply tank 322, and/or the flow rate of recovered sediment 324 delivered to sediment storage 104. In some embodiments, the sludge processing zone 90 may include one or more flow control devices 930, such as a flow control device positioned to regulate the flow of sludge provided to the one or more sludge processing devices 92, a flow control device positioned to regulate the flow of recovered water 320 supplied to the water supply tank 322, and/or a flow control device positioned to regulate the flow of recovered sediment 324 delivered to sediment storage 104. In some embodiments, the instructions of the sludge processing zone control module 916 may include instructions to provide control signals to the one or more flow control devices 930 to increase or decrease the flow of sludge provided to the one or more sludge processing devices 92, the flow of recovered water 320 supplied to the water supply tank 322, and/or the flow of recovered sediment 324 delivered to sediment storage 104.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This U.S. non-provisional application claims priority to and the benefit of U.S. Provisional Application No. 63/765,971, filed Mar. 3, 2025, titled “SYSTEMS AND METHODS FOR CLEANING ELEVATED OPEN STORAGE TANKS,” and is a continuation-in-part of U.S. non-provisional application Ser. No. 18/791,532, filed Aug. 1, 2024, titled “SYSTEMS, METHODS, AND DEVICES FOR INDUSTRIAL TOWER WASTE EXTRACTION,” which application is a divisional of U.S. non-provisional application Ser. No. 17/811,277, filed Jul. 7, 2022, titled “SYSTEMS, METHODS, AND DEVICES FOR INDUSTRIAL TOWER WASTE EXTRACTION,” now U.S. Pat. No. 12,098,068, issued Sep. 24, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. 18/888,586, filed Sep. 18, 2024, titled “ASSEMBLIES AND METHODS FOR MATERIAL EXTRACTION,” which is a divisional of U.S. non-provisional application Ser. No. 17/811,293, filed Jul. 7, 2022, titled “ASSEMBLIES AND METHODS FOR MATERIAL EXTRACTION,” now U.S. Pat. No. 12,137,864, issued Nov. 12, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. 18/772,561, filed Jul. 15, 2024, titled “ASSEMBLIES, APPARATUSES, SYSTEMS, AND METHODS FOR MATERIAL EXTRACTION AND CONVEYANCE,” which is a divisional of U.S. non-provisional application Ser. No. 17/811,295, filed Jul. 7, 2022, titled “ASSEMBLIES, APPARATUSES, SYSTEMS, AND METHODS FOR MATERIAL EXTRACTION AND CONVEYANCE,” now U.S. Pat. No. 12,091,264, issued Sep. 17, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. 18/792,645, filed Aug. 2, 2024, titled “ASSEMBLIES AND METHODS FOR MATERIAL EXTRACTION FROM RETENTION COLLECTIONS,” which is a continuation of U.S. non-provisional application Ser. No. 17/811,280, filed Jul. 7, 2022, titled “ASSEMBLIES AND METHODS FOR MATERIAL EXTRACTION FROM RETENTION COLLECTIONS,” now U.S. Pat. No. 12,103,791, issued Oct. 1, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. 18/963,431, filed Nov. 27, 2024, titled “HIGH VOLUME INDUSTRIAL VACUUM ASSEMBLIES AND METHODS,” which is a divisional of U.S. application Ser. No. 17/811,291, filed Jul. 7, 2022, titled “HIGH VOLUME INDUSTRIAL VACUUM ASSEMBLIES AND METHODS,” now U.S. Pat. No. 12,193,627, issued Jan. 14, 2025, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional Ser. No. 19/011,864, filed Jan. 7, 2025, titled “METHODS FOR LOADING AND EXTRACTING PRODUCT IN ELEVATED TOWER,” which is a continuation of U.S. Non-Provisional Application No. Ser. No. 17/811,288, filed Jul. 2, 2022, titled “METHODS FOR LOADING AND EXTRACTING PRODUCT IN ELEVATED TOWER,” now U.S. Pat. No. 12,246,932, issued Mar. 11, 2025, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. 19/367,957, filed Oct. 24, 2025, titled “AIR COMPRESSOR HAVING VACUUM AND ASSOCIATED METHODS FOR LOADING AND EXTRACTING MATERIALS,” which is a divisional of U.S. non-provisional application Ser. No. 18/214,887, filed Jun. 27, 2023, titled “AIR COMPRESSOR HAVING VACUUM AND ASSOCIATED METHODS FOR LOADING AND EXTRACTING MATERIALS,” now U.S. Pat. No. 12,510,077, issued Dec. 30, 2025, which claims the benefit of and priority to U.S. Provisional Ser. No. 63/373,289 , filed Aug. 23, 2022, and titled “AIR COMPRESSOR HAVING VACUUM AND ASSOCIATED METHODS FOR LOADING AND EXTRACTING MATERIALS,” the contents of which are incorporated herein by reference in their entirety. U.S. non-provisional application Ser. No. 18/214,887 is a continuation-in-part of U.S. non-provisional application Ser. No. 17/811,277, filed Jul. 7, 2022, titled, “SYSTEMS, METHODS, AND DEVICES FOR INDUSTRIAL TOWER WASTE EXTRACTION,” now U.S. Pat. No. 12,098,068, issued Sep. 24, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties. U.S. non-provisional application Ser. No. 18/214,887 is also a continuation-in-part of U.S. non-provisional application Ser. No. 17/811,293, filed Jul. 7, 2022, titled, “ASSEMBLIES AND METHODS FOR MATERIAL EXTRACTION,” now U.S. Pat. No. 12,137,864, issued Nov. 12, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties. U.S. non-provisional application Ser. No. 18/214,887 is also a continuation-in-part of U.S. non-provisional application Ser. No. 17/811,295, filed Jul. 7, 2022, titled, “ASSEMBLIES, APPARATUSES, SYSTEMS, AND METHODS FOR MATERIAL EXTRACTION AND CONVEYANCE,” now U.S. Pat. No. 12,091,264, issued Sep. 17, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties. U.S. non-provisional application Ser. No. 18/214,887 is also a continuation-in-part of U.S. non-provisional application Ser. No. 17/811,280, filed Jul. 7, 2022, titled, “ASSEMBLIES AND METHODS FOR MATERIAL EXTRACTION FROM RETENTION COLLECTIONS,” now U.S. Pat. No. 12,103,791, issued Oct. 1, 2024, which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties. U.S. non-provisional application Ser. No. 18/214,887. This application is also a continuation-in-part of U.S. non-provisional application Ser. No. 17/811,291, filed Jul. 7, 2022, titled, “HIGH VOLUME INDUSTRIAL VACUUM ASSEMBLIES AND METHODS,” which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their U.S. non-provisional application Ser. No. 18/214,887 is also a continuation-in-part of U.S. non-provisional application Ser. No. 17/811,288, filed Jul. 7, 2022, titled, “RECEIVER, ASSEMBLIES, AND METHODS FOR LOADING AND EXTRACTING PRODUCT INELEVATED TOWER,” which claims priority to and the benefit of U.S. Provisional Application No. 63/367,570, filed Jul. 1, 2022, titled “HIGH VOLUME INDUSTRIAL VACUUM ASSEMBLIES AND METHODS,” U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER,” U.S. Provisional Application No. 63/367,218, filed Jun. 29, 2022, titled “ASSEMBLIES AND METHODS FOR MATERIAL EXTRACTION FROM RETENTION COLLECTIONS,” U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE,” U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

This application is a continuation-in-part of U.S. non-provisional application Ser. No. 19/371,759, filed Oct. 28, 2025, titled “SYSTEMS, ASSEMBLIES, AND METHODS FOR PYROPHORIC MATERIAL EXTRACTION,” which is a divisional of U.S. Non-Provisional Application No. Ser. No. 18/459,545, filed Sep. 1, 2023, titled “SYSTEMS, ASSEMBLIES, AND METHODS FOR PYROPHORIC MATERIAL EXTRACTION,” now U.S. Pat. No. 12,485,459, issued Dec. 2, 2025, which claims priority to and the benefit of U.S. Provisional Application No. 63/375,500, filed Sep. 13, 2022, titled “SYSTEMS, ASSEMBLIES, AND METHODS FOR PYROPHORIC MATERIAL EXTRACTION.” U.S. non-provisional application Ser. No. 18/459,545 is also a continuation-in-part of U.S. non-provisional application Ser. No. 18/214,887, filed Jun. 27, 2023, titled “AIR COMPRESSOR HAVING VACUUM AND ASSOCIATED METHODS FOR LOADING AND EXTRACTING MATERIALS,” which claims the benefit of and priority to U.S. Provisional Ser. No. 63/373,289 , filed Aug. 23, 2022, titled “AIR COMPRESSOR HAVING VACUUM AND ASSOCIATED METHODS FOR LOADING AND EXTRACTING MATERIALS”; and is a continuation-in-part of and claims benefit and priority to U.S. non-provisional application Ser. No. 17/811,295, filed Jul. 7, 2022, titled, “ASSEMBLIES, APPARATUSES, SYSTEMS, AND METHODS FOR MATERIAL EXTRACTION AND CONVEYANCE,” now U.S. Pat. No. 12,091,264, issued Sep. 17, 2024, which claims the benefit of and priority to U.S. Provisional Application No. 63/364,630, filed May 13, 2022, titled “ASSEMBLIES, APPARATUSES, SYSTEMS, AND METHODS FOR MATERIAL EXTRACTION AND CONVEYANCE”; and is a continuation-in-part of and claims benefit and priority to U.S. non-provisional application Ser. No. 17/811,293, filed Jul. 7, 2022, titled, “ASSEMBLIES AND METHODS FOR MATERIAL EXTRACTION” now U.S. Pat. No. 12,137,864, issued Nov. 12, 2024; and is a continuation-in-part of and claims benefit and priority to U.S. non-provisional application Ser. No. 17/811,291, filed Jul. 7, 2022, titled, “HIGH VOLUME INDUSTRIAL VACUUM ASSEMBLIES AND METHODS,” which claims the benefit of and priority to U.S. Provisional Application No. 63/367,570, filed Jul. 1, 2022, titled “HIGH VOLUME INDUSTRIAL VACUUM ASSEMBLIES AND METHODS”; and is a continuation-in-part of and claims benefit and priority to U.S. non-provisional application Ser. No. 17/811,288, filed Jul. 7, 2022, titled, “RECEIVER, ASSEMBLIES, AND METHODS FOR LOADING AND EXTRACTING PRODUCT INELEVATED TOWER,” which claims the benefit of and priority to U.S. Provisional Application No. 63/367,219, filed Jun. 29, 2022, titled “RECEIVER, ASSEMBLIES, AND METHODS FOR LOADING AND EXTRACTING PRODUCT IN ELEVATED TOWER”; and is a continuation-in-part of and claims benefit and priority to U.S. non-provisional application Ser. No. 17/811,280, filed Jul. 7, 2022, titled, “ASSEMBLIES AND METHODS FOR MATERIAL EXTRACTION FROM RETENTION COLLECTIONS,” now U.S. Pat. No. 12,103,791, issued Oct. 1, 2024, which claims the benefit of and priority to U.S. Provisional Application No. 63/367,218, filed Jun. 29, 2022, titled “ASSEMBLIES AND METHODS FOR MATERIAL EXTRACTION FROM RETENTION COLLECTIONS”; and is a continuation-in-part of and claims benefit and priority to U.S. non-provisional application Ser. No. 17/811,277, filed Jul. 7, 2022, titled, “SYSTEMS, METHODS, AND DEVICES FOR INDUSTRIAL TOWER WASTE EXTRACTION,” now U.S. Pat. No. 12,098,068, issued Sep. 24, 2024, which claims the benefit of and priority to U.S. Provisional Application No. 63/264,101, filed Nov. 16, 2021, titled “ASSEMBLIES AND METHODS FOR MATERIAL EXTRACTION,” U.S. Provisional Application No. 63/264,015, filed Nov. 12, 2021, titled “ASSEMBLIES AND METHODS FOR MATERIAL EXTRACTION,” U.S. Provisional Application No. 63/203,147, filed Jul. 9, 2021, titled “SYSTEMS, METHODS, AND DEVICES FOR INDUSTRIAL TOWER WASTE EXTRACTION,” and U.S. Provisional Application No. 63/203,108, filed Jul. 8, 2021, titled “SYSTEMS, METHODS, AND DEVICES FOR INDUSTRIAL TOWER WASTE EXTRACTION,” the disclosures of all of which are incorporated herein by reference in their entireties.

Furthermore, the scope of the present disclosure shall be construed to cover various modifications, combinations, additions, or alterations above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. A system for extracting and processing sludge from an elevated open storage tank, the system comprising:
one or more vacuum generation assemblies, the one or more vacuum generation assemblies including one or more compressors configured to provide a pressurized fluid and one or more vacuum generators each having one or more venturi mechanisms configured to receive the pressurized fluid and generate a vacuum flow using a venturi effect;
a submersible robot including a water jet configured to receive a pressurized water stream and a suction head configured to receive the vacuum flow generated by the one or more vacuum generation assemblies, the submersible robot being configured to deliver the pressurized water stream via the water jet to fluidize the sludge within the elevated open storage tank, thereby to yield a fluidized sludge, and configured to extract the fluidized sludge from the elevated open storage tank via the suction head; and
one or more sludge processing devices configured to receive and process the fluidized sludge, thereby to yield a recovered water stream and sediment, the recovered water stream being recycled to form at least a portion of the pressurized water stream.

2. The system of claim 1, wherein the one or more vacuum generation assemblies are configured to generate a pressure that ranges from about 400,000 Pascals to about 900,000 Pascals to generate the vacuum flow.

3. The system of claim 1, wherein the vacuum flow generated by the one or more vacuum generation assemblies ranges from about 200 cubic feet per minute to about 800 cubic feet per minute at 100 pounds per square inch.

4. The system of claim 1, wherein the water jet of the submersible robot is fluidly connected to a water pump via a high-pressure hose to receive the pressurized water stream, and the suction head of the submersible robot is fluidly connected to the one or more vacuum generation assemblies via a vacuum hose having a diameter of at least 6 inches to receive the vacuum flow.

5. The system of claim 1, comprising a plurality of vacuum boxes configured to receive and collect the fluidized sludge extracted by the submersible robot and configured to provide the fluidized sludge to the one or more sludge processing devices.

6. The system of claim 5, wherein the plurality of vacuum boxes is fluidly connected to (i) the one or more vacuum generation assemblies to receive the vacuum flow, (ii) the submersible robot to provide the vacuum flow to the suction head, and (iii) the one or more sludge processing devices to provide the fluidized sludge to the one or more sludge processing devices.

7. The system of claim 5, comprising a diaphragm pump fluidly connected between the plurality of vacuum boxes and the one or more sludge processing devices, the diaphragm pump being configured to pump the fluidized sludge from the plurality of vacuum boxes to the one or more sludge processing devices.

8. The system of claim 5, wherein the plurality of vacuum boxes each comprise one or more water jets fluidly connected to a water pump and configured to receive and deliver a second pressurized water stream to maintain or restore fluidization of the fluidized sludge within the plurality of vacuum boxes.

9. The system of claim 8, wherein the recovered water stream is recycled to form at least a portion of the second pressurized water stream.

10. The system of claim 1, wherein the one or more sludge processing devices comprise a shaker, a desander, a desilter, a centrifuge, or any combination thereof.

11. The system of claim 1, comprising a flocculant supply configured to combine one or more flocculants with the fluidized sludge before or during processing the fluidized sludge within the one or more sludge processing devices.

12. The system of claim 1, wherein the elevated open storage tank has a height of at least 45 feet, and wherein the one or more vacuum generation assemblies comprise:
a first vacuum generation assembly including a first vacuum generator having four venturi mechanisms fluidly connected to receive the pressurized fluid from a first compressor; and
a second vacuum generation assembly including a second vacuum generator having four venturi mechanisms fluidly connected to receive the pressurized fluid from a second compressor.

13. The system of claim 1, wherein the one or more compressors comprise one or more air compressors and the pressurized fluid comprises compressed air.

14. The system of claim 1, wherein the one or more vacuum generation assemblies comprise one or more hydrogen sulfide (H₂S) scrubbers fluidly connected to the one or more vacuum generation assemblies and configured to remove H₂S gas from an exhaust stream of the one or more venturi mechanisms of the one or more vacuum generators.

15. A method of extracting and processing sludge from an elevated open storage tank, the method comprising:
lowering a submersible robot through an open top of the elevated open storage tank;
activating a first water pump to supply a first pressurized water stream to a water jet of the submersible robot, thereby to yield a fluidized sludge;
activating one or more vacuum generation assemblies to provide a vacuum flow to a suction head of the submersible robot, thereby to extract the fluidized sludge from the elevated open storage tank using the vacuum flow;
providing the fluidized sludge to one or more sludge processing devices;
activating the one or more sludge processing devices to process the fluidized sludge, thereby to yield a recovered water stream and sediment; and
recycling the recovered water stream to form at least a portion of the first pressurized water stream.

16. The method of claim 15, wherein the lowering of the submersible robot through the open top of the elevated open storage tank comprises providing control signals to a crane operably connected to the submersible robot to cause the crane to lower the submersible robot through the open top of the elevated open storage tank.

17. The method of claim 15, wherein the providing of the fluidized sludge to the one or more sludge processing devices comprises:
delivering the fluidized sludge extracted by the suction head of the submersible robot directly to the one or more sludge processing devices via a vacuum hose that is fluidly connected between the suction head of the submersible robot and the one or more sludge processing devices.

18. The method of claim 15, wherein the providing of the fluidized sludge to the one or more sludge processing devices comprises:
delivering the fluidized sludge into a plurality of vacuum boxes; and
activating a diaphragm pump to pump the fluidized sludge from the plurality of vacuum boxes to the one or more sludge processing devices.

19. The method of claim 18, further comprising:
determining that a volume of the fluidized sludge in the plurality of vacuum boxes is less than a predefined minimum volume, and in response, deactivating at least the diaphragm pump and the one or more sludge processing devices to cease sludge processing until the volume of the fluidized sludge in the plurality of vacuum boxes is greater than or equal to the predefined minimum volume.

20. The method of claim 18, further comprising:
determining that a volume of the fluidized sludge in the plurality of vacuum boxes is greater than a predefined maximum volume, and in response, deactivating at least the one or more vacuum generation assemblies and the first water pump to cease sludge extraction and collection until the volume of the fluidized sludge in the plurality of vacuum boxes is less than or equal to the predefined maximum volume.

21. The method of claim 18, wherein the providing of the fluidized sludge to the one or more sludge processing devices further comprises:
activating a second water pump to supply a second pressurized water stream to one or more vacuum box water jets to maintain or restore fluidization of the fluidized sludge within the plurality of vacuum boxes.

22. The method of claim 15, wherein the providing of the fluidized sludge to the one or more sludge processing devices comprises:
combining the fluidized sludge with one or more flocculants and providing the combination of the fluidized sludge and the one or more flocculants to the one or more sludge processing devices for processing.
